(19) United States
(12) Patent Application Publication
(10) Pub. No.: US 2006/0042020 A1
(43) Pub. Date: Mar. 2, 2006

(54) Treatment of fabrics, fibers, or yarns

(75) Inventors: Sonja Salmon, Raleigh, NC (US); Caroline Shi, Ouincy, MA (US); Jiyin Liu, Raleigh, NC (US)

Correspondence Address: NOVOZYMES NORTH AMERICA, INC., 500 FIFTH AVENUE, SUITE 1600, NEW YORK, NY, 10110, US

(73) Assignee: Novozymes North America, Inc., Franklinton, NC (US)

(21) Appl. No.: 10/540,191

(22) PCT Filed: Dec. 19, 2003
(86) PCT No.: PCT/US03/40736

§ 371 Date: Jun. 20, 2005

Related U.S. Application Data
(60) Provisional application No. 60/434,975, filed on Dec. 20, 2002.
(60) Provisional application No. 60/491,717, filed on Jul. 31, 2003.

(51) Int. Cl. C11D 3/00

(52) U.S. Cl. 8/115.51

(57) ABSTRACT

The present invention relates to a method for treating textiles with a carbohydrate oxidase and/or a fatty acid oxidizing enzyme.

### FIELD OF THE INVENTION

The present invention relates to a method of treating textiles, in particular fabrics, fibers, or yarns comprising treating the fabric, fiber, or yarn in an aqueous medium with a carbohydrate oxidase and/or a fatty add oxidizing enzyme. More particularly, the invention relates to using carbohydrate oxidase in a method for bleaching textiles, in particular fabrics, fibers, or yarn to obtain an improved level of whiteness. The present invention also relates to a method of treating textiles with a fatty acid oxidizing enzyme and the use of a fatty acid oxidizing enzyme for improving the wettability of textiles (water absorbance) and/or whiteness of textiles.

### BACKGROUND OF THE INVENTION

Preparatory processes are necessary for removing natural and man-induced impurities from fibers and for improving their aesthetic appearance and processability prior to for instance dyeing, printing and finishing. This purification treatment is referred to as preparation. Common preparation processes include desizing of cotton, silk and synthetic fibers, scouring of cotton and wool, and bleaching.

Sizing may be necessary to prevent breakage and lower processing speeds of a variety of natural and synthetic fiber yarns during their weaving. Common size agents are starches (or starch derivatives and modified starches), poly(vinyl alcohol), carboxyl methyl cellulose (i.e. CMC) where starches are dominant. Paraffin, acrylic binders and variety of lubricants are often included in the size mix. After the fabric is made, size on the fabric must be removed again (i.e. desizing).

Desizing is the degradation and/or removal of sizing compounds from warp yarns in a woven fabric. Starch is usually removed by an enzymatic desizing procedure. In addition, oxidative desizing and chemical desizing with acids or bases are sometimes used. Typical enzymes for desizing are alpha-amylase, beta-amylase, amyloglucosidase, or mixtures thereof (see e.g. U.S. Pat. No. 5,364,782, U.S. Pat. No. 5,769,900, U.S. Pat. No. 6,017,751). Cellulase and lipase are also used either alone or combined with amylase for desizing (WO 96/05353, Textile Chemist and Colorist 29(6), 23-26(1999)).

Scouring is used to remove impurities from the fibers, to swell the fibers and to solubilize seed coat. It is one of the most critical steps. The main purposes of scouring is to a) uniformly clean the fabric, b) soften the motes and other trashes, c) improve fabric absorbency, d) saponify and solubilize fats, oils, and waxes, and e) minimize immature cotton. Sodium hydroxide scouring at about boiling temperature Is the accepted treatment for 100% cotton, while calcium hydroxide and sodium carbonate are less frequently used. Synthetic fibers are scoured at much milder conditions. Surfactant and chelating agents are essential for alkaline scouring (Alkaline treatment of cellulose fibers, in Handbook of fiber Science and Technology 1(A), Textile Processing and Properties, in Textile Sciences and Technology 11). Enzymatic scouring has been introduced recently (U.S. Pat. No. 5,912,407, JP 51-149976, WO 98/06857, U.S. Pat. No. 6,066,494). Cellulase, hemicellulase, pectinase, lipase, and protease are all reported to have scouring effects.

Bleaching is the destruction of pigmented color and colored Impurities as well as seed coat fragment removal. It is the most critical chemical treatment since a balance between the degrees of whiteness without fiber damage must be maintained. Bleaching is performed by the use of oxidizing or reducing chemistry. Oxidizing agents can be further subdivided into those that employ or generate: a) hypochlorite (OCl⁻), b) chloride dioxide (ClO₂), and hydroperoxide species (OOH⁻ and/or OOH). Reducing agents are typical sulfur dioxide, hydrosulfite salts, etc. Enzymatic bleaching using glucose oxidase has been reported (Ishihara, et al, Enzymatic Processes for Bleaching Cotton Fabrics, Shizuoka-Ken Hamamatsu Kogyo Gijutsu Senia Kenkyu Hokoku 7, 7-13 (1997). Buschle-Diller and Yang, Enzymatic Bleaching of Cotton Fabric with Glucose Oxidase, Textile Res. J. 71(5), 388-394 (2001). Tzanov, et al, Bio-Preparation of Cotton Fabrics, Enzyme Microb. Technol. 29, 357-362 (2001).

In industrial practice, equipment availability, fabric construction and customer requirements all influence the choice of processes of preparation. Various batch, demi-continuous, and continuous processes are used. In order to give the optimum base fabric for subsequent dyeing and finishing for production of quality products, a total engineered strategy for desizing, scouring and bleaching must be employed. The most commonly used strategy is 1) single stage preparation where desizing, scouring and bleaching are conducted in one operation, 2) three-stage preparation where the operations are conducted in sequence as desizing-wash-scouring-wash-bleaching-wash. While the single-stage approach saves energy and floor space, the conventional three-stage operation gives high quality of prepared fabrics.

Buschle-Diller et al.: Enzymatic Bleaching of Cotton Fabric with Glucose Oxidase, Textile Res. J. 71(5), 388-394 (2001) discloses that the treatment bath from the desizing with amyloglucosidase combined with bioscouring of cotton fabric can be reused for enzymatic bleaching with glucose oxidase. The reference discloses that after generation of peroxide by glucose oxidase in a first step, the pH was adjusted to 7 and bleaching performed at 85-90° C. for 60-120 minutes in a second step.

Tzanov et al.: Bio-preparation of cotton fabrics, Enzyme and Microbial Technology 29 (2001), 357-362 discloses an enzymatic process for scouring and bleaching of cotton fabrics based on the use of pectinase and glucose oxidase.

There is still a need for improved processes for treating textiles.

### SUMMARY OF THE INVENTION

In the main aspect the invention relates to a method of treating textiles, In particular fabrics, fibers, or yarns comprising treating fabric, fiber, or yarn, in an aqueous medium, with a carbohydrate oxidase and/or a fatty acid oxidizing enzyme.

In one embodiment the invention provides an enzyme-based method for treating textiles, in particular fabrics, fibers or yarn, comprising treating the fabric, fiber, or yarn in an aqueous medium with a carbohydrate oxidase, and in particular to a method for bleaching fabric, fiber or yarn. Carbohydrate oxidases have activity towards a plurality of substrates, i.e., the carbohydrate oxidase has activity towards mono-saccharides and at least one of di-saccharides and oligo-saccharides. Accordingly, although not limited to any one theory of operation, the use of a carbohydrate oxidase in accordance with the present invention is advantageous in that bleaching can be carried out against a broad range of substrates. The bleaching process can be carried out with the choice between different substrates making the method more applicable for the bleaching purpose as the person to conduct the bleaching process can choose from a broader range of sugar substrates either generated in situ with another enzyme or chemical system, from starch sizing and/or cellulosic fiber or added which is not the case when limited to a specific choice of substrate. In addition, the method can be carried out without the use of environmentally damaging chemicals and without using large amounts of rinse water.

One embodiment of the invention provides a method of manufacturing a bleached fabric, fiber or yarn comprising treating fabric, fiber or yarn in an aqueous medium with an effective amount of a carbohydrate oxidase and a carbohydrate oxidase substrate.

In another embodiment, the present invention provides an improved method of treating textiles with a fatty acid oxidizing enzyme. The present inventors have found that a fatty acid oxidizing enzyme advantageously may be used for treatment of textiles. Thus, in this aspect the invention relates to a method of treating textile, in particular fabrics, garments, or yarns, comprising a step of treating the textile in an aqueous medium with one or more fatty acid oxidizing enzyme.

In a third aspect the invention relates to a composition comprising a fatty acid oxidizing enzyme and in addition thereto at least one adjuvant. Examples of adjuvants, which are used for treating textiles, include wetting agents, such as certain surfactants; polymeric agents; and dispersing agents.

At least in context of the present invention the terms “method” and “process” may be used interchangeably.

### DETAILED DESCRIPTION OF THE INVENTION

In the main aspect the invention relates to a method of treating textiles, in particular fabrics, fibers, or yarns comprising treating fabric, fiber, or yarn, in an aqueous medium, with a carbohydrate oxidase and/or a fatty acid oxidizing enzyme.

The present invention is directed to a method for bleaching fabrics, fibers and yarns, wherein the fabrics, fibers, and yarns are treated in an aqueous medium with an effective amount of a carbohydrate oxidase having activity towards monosaccharides and at least one of di-saccharides and oligo-saccharides and a substrate for said carbohydrate oxidase.

The present invention also provides an improved method of treating textiles. The present inventor has found that a fatty acid oxidizing enzyme advantageously may be used for treatment of textiles. The inventor found that when using a fatty acid oxidizing enzyme for treating textiles bleaching is observed. An alkaline treatment using sodium hydroxide (NaOH) at high temperatures (around 95° C.) further increased the bleaching effect. It was also found that the presence of a substrate to the fatty acid oxidizing enzyme (e.g., lenoleic acid) has a whitening effect on the textile. When the fatty acid oxidizing enzyme is used together with a pectolytic enzyme on a textile the fabric wettability (i.e., wetting time) is enhanced. Combining the fatty acid oxidizubg enzymes with a substrate thereto increases the whiteness of the textile. When a fatty acid oxidizing enzyme is used on desized textiles together with a lipolytic enzyme and a pectolytic enzyme the whiteness is improved. Addition of a substrate to the fatty acid oxidizing enzyme further improves the whiteness. When using a fatty acid oxidizing enzyme alone or in combination with a substrate for desizing of textiles in the presence of an amylase or an amylase and a lipolytic enzyme the whiteness and fabric wettability is improved.

The term “textiles” used herein is meant to include fabrics, garments, or yarns.

As used herein, the singular forms “a”, “an”, and “the” include plural references unless the context clearly dictates otherwise. Thus, for example, references to “carbohydrate oxidase” include the use of one or more carbohydrate oxidases and references to “fatty acid oxidizing enzyme” include the use of one or more fatty acid oxidizing enzymes.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned herein are incorporated herein by reference for the purpose of disclosing and describing the material for which the reference was cited in connection with.

EC-numbers may be used for classification of enzymes. Reference is made to the Recommendations (1992) of the Nomenclature Committee of the International Union of Biochemistry and Molecular Biology, Academic Press Inc., 1992.

It is to be understood that the term enzyme, as well as the various enzymes and enzyme classes mentioned herein, encompass wild-type enzymes, as well as any variant thereof that retains the activity in question. Such variants may be produced by recombinant techniques. The wild-type enzymes may also be produced by recombinant techniques, or by isolation and purification from the natural source. In an embodiment the enzyme in question is well-defined, meaning that only one major enzyme component is present. This can be inferred, e.g., by fractionation on an appropriate size-exclusion column. Such well-defined, or purified, or highly purified, enzyme can be obtained as is known in the art and/or described in publications relating to the specific enzyme in question.

Even if not specifically mentioned in connection with treatment of textiles with (an) enzyme(s) or agent(s) according to the method of the invention, it is to be understood that the enzyme(s) or agent(s) is(are) used in an “effective amount”. The term “effective amount” means in the context of the present invention an amount of carbohydrate oxidase that is able to generate enough hydrogen peroxide to provide bleaching of the textile material as compared to a textile material which has not been treated with a carbohydrate oxidase. In context of, e.g., fatty acid oxidizing enzyme it means the amount of enzyme capable of providing the desired effect, such as desizing, scouring, and/or bleaching effect on the textile as compared to a textile which has not been treated with said fatty acid oxidizing enzyme.

The term “applied together with” (or “used together with”) means that the additional enzyme may be applied in the same, or in another step of the method of the invention. The other treatment step(s) in the method of the invention may be carried out upstream or downstream in the textile treatment method, as compared to the step in which the textile is treated with a fatty acid oxidizing enzyme.

The term “a step” of a method means at least one step, and it could be one, two, three, four, five or even more method steps. In other words the fatty acid oxidizing enzyme used according to the invention may be applied in at least one method step, and the additional enzyme(s) may also be applied in at least one method step, which may be the same or a different method step as compared to the step where the fatty acid oxidizing enzyme is used.

The term “bleaching” is here defined as a whitening of the fabric, fiber, or yarn. The value of whiteness index (WI) is measured using a MacBeth Color Eye equipped with Optiview 7000 software. The Whiteness index is calculated from the following equation:
WI=Y+800(xₙ−x)+1700(yₙ−y)
where Y, x and y are chromaticity coordinates of the sample, and xₙ and yₙ are those of illuminant using the standard illuminant D65.
Textiles

In context of the invention the term “textile” includes fabrics, garments, and yarns.

Fabric can be constructed from fibers by weaving, knitting or non-woven operations. Weaving and knitting require yarn as the input whereas the non-woven fabric is the result of random bonding of fibers (paper can be thought of as non-woven). In the present context, the term “fabric” is also intended to include fibers and other types of processed fabrics.

Woven fabric is constructed by weaving “filling” or weft yarns between wrap yarns stretched in the longitudinal direction on the loom. The wrap yarns must be sized before weaving in order to lubricate and protect them from abrasion at the high speed insertion of the filling yarns during weaving. The filling yarn can be woven through the warp yarns in a “over one—under the next” fashion (plain weave) or by “over one—under two” (twill) or any other myriad of permutations. Strength, texture and pattern are related not only to the type/quality of the yarn but also the type of weave. Generally, dresses, shirts, pants, sheeting's, towels, draperies, etc. are produced from woven fabric.

Knitting is forming a fabric by joining together interlocking loops of yarn. As opposed to weaving which is constructed from two types of yarn and has many “ends”, knitted fabric is produced from a single continuous strand of yarn. As with weaving, there are many different ways to loop yarn together and the final fabric properties are dependent both upon the yarn and the type of knit. Underwear, sweaters, socks, sport shirts, sweat shirts, etc. are derived from knit fabrics.

Non-woven fabrics are sheets of fabric made by bonding and/or interlocking fibers and filaments by mechanical, thermal, chemical or solvent mediated processes. The resultant fabric can be in the form of web-like structures, laminates or films. Typical examples are disposable baby diapers, towels, wipes, surgical gowns, fibers for the “environmental friendly” fashion, filter media, bedding, roofing materials, backing for two-dimensional fabrics and many others.

According to the invention, the method of the invention may be applied to any fabric known in the art (woven, knitted, or non-woven). In particular the bleaching process may be applied to cellulose-containing or cellulosic fabrics, such as cotton, viscose, rayon, ramie, linen, lyocell (e.g. Tencel, produced by Courtaulds Fibers), or mixtures thereof, or mixtures of any of these fibers together with synthetic fibres (e.g., polyester, polyamid, nylon) or other natural fibers such as wool and silk., such as viscose/cotton blends, lyocell/cotton blends, viscose/wool blends, lyocell/wool blends, cotton/wool blends; flax (linen), ramie and other fabrics based on cellulose fibers, including all blends of cellulosic fibers with other fibers such as wool, polyamide, acrylic and polyester fibers, e.g., viscose/cotton/polyester blends, wool/cotton/polyester blends, flax/cotton blends etc. The term “wool,” means any commercially useful animal hair product, for example, wool from sheep, camel, rabbit, goat, llama, and known as merino wool, Shetland wool, cashmere wool, alpaca wool, mohair, etc. and includes wool fiber and animal hair. The method of the invention can be used with wool or animal hair material in the form of top, fiber, yarn, or woven or knitted fabric. The enzymatic treatment can also be carried out on loose flock or on fibers made from wool or animal hair material. The treatment can be performed at many different stages of processing. The fabric to be bleached may be dyed or undyed. According to the invention textile may be desized, scoured and/or bleached in aqueous medium in the presence of a fatty acid oxidizing enzyme.

Mote Particles

Mote particles are dark brown particles found on unbleached cotton fabric, also called “dark spots”. They are cotton pod and stem residues originating from the mechanical picking of cotton. The brown color is due to the high lignin content of the mote particles.

Desizing

According to the invention desizing may be carried out at conditions chosen to suit the method according to principles well known in the art. In an embodiment a sized fabric in either rope or open width form is brought in contact with the processing liquid containing a fatty acid oxidizing enzyme and desizing agents. The desizing agents employed depend upon the type of size to be removed. The most common sizing agent is based upon starch. Therefore in a preferred embodiment the textile is desized by a combination of hot water (i.e., 50-100° C., preferably 60° C. to 80° C.), an alpha-amylase and a wetting agent and/or surfactant.

The textile is allowed to stand with the desizing agents for a “holding period” sufficiently long to accomplish the desizing. The holding period is dependent upon the type of processing regime and the temperature and can vary from 15 minutes to 2 hours, or in some cases, several days. Typically, the desizing agents are applied in a saturator bath which generally ranges from about 15° C. to 60° C. The textile is then held in equipment such as a “J-box” which provides sufficient heat, usually between 50° C. and 100° C. to enhance the activity of the desizing agents. The agents, including the removed sizing agents, are washed away from the textile after the termination of the holding period.

In order to ensure a high whiteness and/or a good dyeability, the size and other applied agents must be thoroughly removed, and it is generally believed that an efficient desizing is of crucial importance to the following preparation processes: scouring and bleaching.

Scouring

According to the invention scouring may be carried out at conditions chosen to suit the process according to principles well known in the art. A scouring process employs sodium hydroxide (NaOH) or related causticizing agents such as sodium carbonate, potassium hydroxide or mixtures thereof. Generally an alkali stable surfactant is added to the process to enhance solubilization of hydrophobic compounds and/or prevent their re-deposition back on the textile. The treatment is generally at a high temperature, i.e., 10° C.-100° C., preferably 40° C. to 60° C., employing strongly alkaline solutions, i.e., above pH 9, preferably 9-13, of the scouring agent. Due to the non-specific nature of chemical processes not only are the impurities but the, e.g., cellulose itself is attacked, leading to damages in strength or other desirable textile properties. The softness of a cellulosic fabric is a function of residual natural cotton waxes. The non-specific nature of the high temperature strongly alkaline scouring process cannot discriminate between the desirable natural cotton lubricants and the manufacturing introduced lubricants.

The scouring stage prepares the textile for the optimal response in bleaching. An inadequately scoured fabric will need a higher level of bleach chemical in the subsequent bleaching stages.

Bleaching

According to the invention bleaching may be carried out using any know process conditions in the art. In an embodiment the bleaching may be carried out at a temperature in the range of from about 30° C. to about 100° C., more preferably from about 40° C. to about 90° C. The pH range may, dependent on the enzyme(s) applied, preferably be from about pH 5 to about pH 11, more preferably from about pH 6 to about pH 8. The reaction time may preferably be in the range of from about 15 minutes to about 3 hours.

The term “bleaching” is here defined as a whitening of the textile. The value of whiteness index (WI) is measured using a MacBeth Color Eye equipped with Optiview 7000 software. The Whiteness index is calculated from the following equation:
WI=Y+800(xₙ−x)+1700(yₙ−y)
where Y, x and y are chromaticity coordinates of the sample, and xₙ and yₙ are those of illuminant using the standard illuminant D65 (imitating daylight).

### METHODS OF THE INVENTION

As mentioned above, in the first aspect, the invention relates to q method of treating textiles, in particular fabrics, fibers, or yarns comprising treating fabric, fiber, or yarn, in an aqueous medium, with a carbohydrate oxidase and/or a fatty acid oxidizing enzyme.

In a one embodiment the invention provides a method of treating fabrics, fibers, or yarns comprising treating fabric, fiber, or yarn in an aqueous medium with an effective amount of a carbohydrate oxidase having activity towards monosaccharides and at least one of di-saccharides and oligo-saccharides and a substrate for said carbohydrate oxidase.

Another embodiment of the invention provides a composition for use in a method of treating fabrics, fibers, or yarns comprising a carbohydrate oxidase having activity towards monosaccharides and at least one of di-saccharides and oligo-saccharides and a substrate for said carbohydrate oxidase.

The treatment according to the present invention may be carried out at conditions chosen to suit the bleaching method according to principles well known in the art. It will be understood that each of the reaction conditions, such as, e.g., concentration/dose of enzyme/substrate, pH, temperature, and time of treatment, may be varied, depending upon, e.g., the source of the enzyme, the type of substrate, the method in which the treatment is performed.

The method of the invention may further comprise the addition of one or more chemicals capable of improving the enzyme-substrate interaction (in order to improve the substrate's accessibility and/or dissolve reaction products), which chemicals may be added prior to, or simultaneously with the enzymatic treatment. Such chemicals may in particular be wetting agents and dispersing agents etc., or mixtures thereof. Such chemicals also encompass peroxidase activators, e.g. silicate.

The enzymatic treatment according to the present invention preferably is carried out as a wet process. An example of a suitable liquor:textile ratio may be in the range of from about 20:1 to about 1:1, preferably in the range of from about 15:1 to about 5:1.

The carbohydrate oxidase is generally added in an amount which is effective to generate enough peroxide for providing the bleaching effect of the textile material. The enzyme(s) may preferably be dosed in an amount of from about 0.05 U/ml to about 10 U/ml of the total liquor, more preferably, from about 0.5 U/ml to about 5 U/ml, most preferably, from about 1 U/ml to about 3 U/ml.

The bleaching method can be carried out with the choice between different substrates either generated in situ with another enzyme or chemical system, from starch sizing and/or cellulosic fiber or added.

The amount of substrate employed in the method of the invention also depends on different parameters such as the enzyme applied. The amount of substrate is preferably from about 1 to about 200 mM of the total liquor, more preferably, from about 3 to about 75 mM, even more preferably, from about 10 to about 40 mM.

The enzymatic treatment is preferably carried out in a two step method, wherein the first step is a peroxide generating step in which the peroxide generating reaction is carried out. The second step is the actual bleaching step in which the textile material is contacted with the generated peroxide.

In the first peroxide generating step, the fabric is incubated with the carbohydrate oxidase and a suitable substrate, e.g., alpha-glucose, and optionally other ingredients, such as buffer solution and surfactants, preferably at about 30° C. to about 50° C., more preferably, around 30° C., preferably at a pH in the range of about 5.5 to about 11, more preferably, about 5.5 to about 9, and even more preferably at about 7 preferably for 1 to 5 hours to generate peroxide. After incubation, the pH is preferably adjusted to a value above pH 7, such as, by adding an alkaline solution, e.g. sodium hydroxide and the temperature is preferably adjusted to a range of from about 75° C. to about 100° C., more preferably, about 80° C. to about 95° C., and even more preferably to around 90° C. The pH range is preferably in the range of about 10 to about 13, more preferably above about 12. Bleaching is performed under these conditions with the enzymatically produced peroxide, preferably for about 10 minutes to about 120 minutes, more preferably, about 30 minutes to about 90 minutes, and even more preferably around 60 minutes. The fabric may also be added in the bleaching treatment after the peroxide generating step.

The method of the invention may optionally comprise a rinsing step during which the textile is rinsed in hot and cold water.

The materials may also be subject to additional processes. For example, for textile materials, the preparation may include the application of finishing techniques such as desizing and scouring, and other treatment processes, such as imparting antimicrobial properties (e.g., using quaternary ammonium salts), flame retardancy (e.g., by phosphorylation with phosphoric acid or urea), increasing absorbency (by coating or laminating with polyacrylic acid), providing an antistatic finish (e.g., using amphoteric surfactants (N-oleyl-N,N-dimethylglycine)), providing a soil release finish (e.g., using NaOH), providing an antisoiling finish (e.g., using a fluorochemical agent), and providing an antipilling finish (e.g., using NaOH, alcohol).

The method of the invention may be carried out in the presence of conventional fabric, fiber, or yarn finishing agents, including wetting agents, polymeric agents, dispersing agents, etc.

A conventional wetting agent may be used to improve the contact between the substrate and the enzyme used in the method. The wetting agent may be a nonionic surfactant, e.g. an ethoxylated fatty alcohol. A preferred wetting agent is an ethoxylated and propoxylated fatty acid ester such as Berol 087 (product of Akzo Nobel, Sweden).

Examples of suitable polymeris agents include proteins (e.g. bovine serum albumin, whey, casein or legume proteins), protein hydrolysates (e.g. whey, casein or soy protein hydrolysate), polypeptides, lignosulfonates, polysaccharides and derivatives thereof, polyethylene glycol, polypropylene glycol, polyvinyl pyrrolidone, ethylene diamine condensed with ethylene or propylene oxide, ethoxylated polyamines, or ethoxylated amine polymers.

The dispersing agent may preferably be selected from nonionic, anionic, cationic, ampholytic or zwitterionic surfactants. More specifically, the dispersing agent may be selected from carboxymethylcellulose, hydroxypropylcellulose, alkyl aryl sulphonates, long-chain alcohol sulphates (primary and secondary alkyl sulphates), sulphonated olefins, sulphated monoglycerides, sulphated ethers, sulphosuccinates, sulphonated methyl ethers, alkane sulphonates, phosphate esters, alkyl isothionates, acylsarcosides, alkyltaurides, fluorosurfactants, fatty alcohol and alkylphenol condensates, fatty acid condensates, condensates of ethylene oxide with an amine, condensates of ethylene oxide with an amide, sucrose esters, sorbitan esters, alkyloamides, fatty amine oxides, ethoxylated monoamines, ethoxylated diamines, alcohol ethoxylate and mixtures thereof. A preferred dispersing agent is an alcohol ethoxylate such as Berol 08 (product of Akzo Nobel, Sweden).

The bleaching processing may be performed using any machinery known in the art.

The fabric may be further finished by one or more of the following treatments as are known in the art: dyeing, biopolishing, brightening, softening, and/or anti-wrinkling treatment(s).

In a second embodiment the invention relates to a method of treating textile, in particular fabrics, garments, or yarns, comprising a step of treating the textile in an aqueous medium with one or more fatty acid oxidizing enzyme. The treatment may in embodiments of the invention be carried out in order to desized, scour and/or bleach textile as will be explained further below.

Enzymes

The enzymatic method of the invention may be accomplished using any carbohydrate oxidase enzyme which is capable of bleaching fabrics, fibers, and yarns in solution and/or a fatty acid oxidizing enzyme as defined below.

Carbohydrate Oxidases

In the context of the present invention the term “carbohydrate oxidase” is intended to mean an enzyme selected from the group consisting of enzymes classified under EC 1.1.3 (Enzyme Nomenclature; http://www.chem.qmw.ac.uk/iubmb/enzyme/).

Carbohydrate oxidases act on a very broad spectrum of substrates, including monosaccharides, such as glucose and xylose and di- and oligosaccharides, such as cellubiose and maltose.

Carbohydrate oxidase catalyses the following general reaction for peroxide generation at pH 5-8 and temperatures around 30-60° C.:
R—CHO+O₂ R—COOH+H₂O₂

Based on the above mechanism, textile materials can be bleached by hydrogen peroxide, which is generated by carbohydrate oxidase during oxidation of sugar substrates. The sugar substrate may be either added or already present on the textile material as sizing materials.

Suitable substrates are mono-saccharides such as arabinose, xylose, α-glucose, β-gluconase, galactose, mannose, fructose, disaccharides such as cellobiose, lactose, maltose, and oligo-saccharides such as cello-oligosaccharides and malto-oligosaccharides having a degree of polymerization of 3-6, particularly maltotriose, cellotriose, maltotetraose, and cellotetraose.

The enzyme has activity towards monosaccharides and at least one of di-saccharides and oligo-saccharides. The comparison between an enzyme of the present invention and an enzyme outside the scope of protection may be made at a substrate concentration of 1-200 mM and an enzyme concentration of 0.05-10 U/ml by incubating the enzyme with the substrate at pH 5.5-11, and a temperature of 10-65° C. for 4 hours or less. Enzymes falling within the scope of the present invention show activity towards at least one monosaccharide and at least one of di-saccharides and oligo-saccharides whereas enzymes falling outside the scope of the present invention show no activity towards at least one monosaccharide and at least one of di-saccharide and oligosaccharide.

The carbohydrate oxidase may be derived from any origin, including, bacterial, fungal, yeast or mammalian origin.

The carbohydrate oxidase may be derived from a microbial source, such as a fungus, e.g. a filamentous fungus or yeast, in particular Ascomycota fungus, e.g. Euascomycetes, especially Pyrenomycetes such as Acremonium, in particular A. strictum.

The carbohydrate oxidase may further be derived from microorganisms of Xylariales, especially mitosporic Xylariales such as the genus Microdochium, particularly the species M. nivale, more preferably M. nivale CBS 100236. Further microbial sources can be found in U.S. Pat. No. 6,165,761 which is hereby incorporated by reference.

The method of production of said enzyme is discloses in U.S. Pat. No. 6,165,761 which is hereby incorporated by reference.

The Fatty Acid Oxidizing Enzyme

Any fatty acid oxidizing enzyme may be used according to the method of the invention. A fatty acid oxidizing enzyme is an enzyme which hydrolyzes the substrate linoleic acid more efficiently than the substrate syringaldazine. “More efficiently” means with a higher reaction rate. This can be tested using the method described in Example 9, and calculating the difference between (1) absorbancy increase per minute on the substrate linoleic acid (absorbancy at 234 nm), and (2) absorbancy increase per minute on the substrate syringaldazine (absorbancy at 530 nm), i.e., by calculating the Reaction Rate Difference (RRD)=(d(A₂₃₄)/dt−d(A₅₃₀)/dt). If the RRD is above zero, the enzyme in question qualifies as a fatty acid oxidizing enzyme as defined herein. If the RRD is zero, or below zero the enzyme in question is not a fatty acid oxidizing enzyme.

In particular embodiments, the RRD is at least 0.05, 0.10, 0.15, 0.20, or at least 0.25 absorbancy units/minute.

In a particular embodiment of the method of Example 9, the enzymes are well-defined. Still further, for the method of Example 9 the enzyme dosage is adjusted so as to obtain a maximum absorbancy increase per minute at 234 nm, or at 530 nm. In particular embodiments, the maximum absorbancy increase is within the range of 0.05-0.50; 0.07-0.4; 0.08-0.3; 0.09-0.2; or 0.10-0.25 absorbancy units pr. min. The enzyme dosage may for example be in the range of 0.01-20; 0.05-15; or 0.10-10 mg enzyme protein per ml.

In the alternative, a “fatty acid oxidizing enzyme” may be defined as an enzyme capable of oxidizing unsaturated fatty acids more efficiently than syringaldazine. The activity of the enzyme could be compared in a standard oximeter setup as described in Example 8 of the present application at pH 6 and 30° C. including either syringaldazine or linoleic acid as substrates.

In a particular embodiment, the fatty acid oxidizing enzyme is defined as an enzyme classified as EC 1.11.1.3, or as EC 1.13.11.-.EC 1.13.11.-means any of the subclasses thereof, presently forty-nine: EC 1.13.11.1-EC 1.13.11.49. EC 1.11.1.3 is designated fatty acid peroxidase, and EC 1.13.11.-is designated oxygenases acting on single donors with incorporation of two atoms of oxygen.

In a further particular embodiment, the EC 1.13.11.-enzyme is classified as EC 1.13.11.12, EC 1.13.11.31, EC 1.13.11.33, EC 1.13.11.34, EC 1.13.11.40, EC 1.13.11.44 or EC 1.13.11.45, designated lipoxygenase, arachidonate 12-lipoxygenase, arachidonate 15-lipoxygenase, arachidonate 5-lipoxygenase, arachidonate 8-lipoxygenase, linoleate diol synthase, and linoleate 11-lipoxygenase, respectively.

Lipoxygenase

In a preferred embodiment the fatty acid oxidizing enzyme is a lipoxygenase (LOX), classified as EC 1.13.11.12, which is an enzyme that catalyzes the oxygenation of polyunsaturated fatty acids, especially cis,cis-1,4-dienes, e.g., linoleic acid and produces a hydroperoxide. But also other substrates may be oxidized, e.g. monounsaturated fatty acids.

Microbial lipoxygenases can be derived from, e.g., Saccharomyces cerevisiae, Thermoactinomyces vulgaris, Fusarium oxysporum, Fusarium proliferatum, Thermomyces lanuginosus, Pyricularia oryzae, and strains of Geotrichum. The preparation of a lipoxygenase derived from Gaeumannomyces graminis is described in Examples 3-4 of WO 02/20730. The expression in Aspergillus oryzae of a lipoxygenase derived from Magnaporthe salvinii is described in Example 2 of WO 02/086114, and this enzyme can be purified using standard methods, e.g., as described in Example 4 of WO 02/20730.

Lipoxygenase (LOX) may also be extracted from plant seeds, such as soybean, pea, chickpea, and kidney bean. Alternatively, lipoxygenase may be obtained from mammalian cells, e.g., rabbit reticulocytes.

Lipoxygenase activity may be determined as described in the Materials& Methods section.

The enzymatic treatment according to the present invention preferably is carried out as a wet process. An example of a suitable liquor textile ratio may be in the range of from about 20:1 to about 1:5, preferably in the range of from about 15:1 to about 1:2, especially about 1:1. Examples of effective amounts of lipoxygenase (LOX) are from 0.001 to 400 U/ml treatment liquor, preferably from 0.01 to 100 U/ml treatment liquor, more preferably 0.05 to 50 U/ml treatment liquor, and even more preferably 0.1 to 20 U/ml treatment liquor. Further optimization of the amount of lipoxygenase can hereafter be obtained using standard procedures known in the art

Substrate

In a preferred embodiment the method of the invention is carried out in the presence of a substrate of the fatty acid oxidizing enzyme. In an embodiment the fatty acid oxidizing enzyme is applied together with a substrate for the enzyme capable of enhancing the enzymatic effect. Examples of such substrates are hydrolyzed oils such as oils from soybeans (rich in linoleic acid) or tall oil. Fatty acid substrates may be released from the added oil by lipolytic enzymes or produced during the Kraft pulping or sulphate cooking.

In particular embodiments the substrate is a compound with 1,4-pentadien structure, e.g. with cis,cis-1,4-pentadien structure, i.e. compounds having at least one such element in its structural formula. Examples of such substrates are unsaturated fatty acids, e.g. palmitoleic acid, oleic acid, linoleic acid, linolenic acid, and arachidonic acid, as well as their salts and esters, e.g. methyl- and ethyl-esters.

In further particular embodiments the substrate is linoleic acid; linoleic acid methyl or ethyl ester, linolenic acid, or linolenic acid methyl or ethyl ester.

To explore the effect of adding a substrate for the fatty acid oxidizing enzyme in question, the following method may be used: The spectrum of 10 mM abietic acid (emulsified in 0.2% Tween 20) is recorded. Characteristic peaks are observed around 200 nm and around 250 nm. In a first experiment, a fatty acid oxidizing enzyme is added to the abietic acid emulsion. In a second experiment, a substrate for the fatty acid oxidizing enzyme is also added. The enzyme is e.g. a lipoxygenase derived from M. salvinii as described above, and the substrate is e.g. linoleic acid. The degradation of abietic acid is followed spectrophotometrically, and the peaks around 200 nm and around 250 nm decrease more rapidly when linoleic acid is added together with the lipoxygenase.

In particular embodiments of the above method, and of the method of the invention, the substrate, e.g., linoleic acid, is added in an amount of 5-10000 ppm (mg/l), or 10-9000, 10-8000, 25-7500, 30-7000, 50-6000, 50-5000, 50-4000, 75-3000, 75-2500, 80-2000, 90-1500, 100-1000, 150-800, or 200-700 ppm. In Example 11, 333 ppm of linoleic acid was used together with a fatty acid oxidizing enzyme.

In further particular embodiments of the above method, and of the method of the invention, the fatty acid oxidizing enzyme is used in an amount of 0.005-50 ppm (mg/l), or 0.01-40, 0.02-30, 0.03-25, 0.04-20, 0.05-15, 0.05-10, 0.05-5, 0.05-1, 0.05-0.8, 0.05-0.6, or 0.1-0.5 ppm. The amount of enzyme refers to mg of a well-defined enzyme preparation.

Additional Enzymes

The carbohydrate oxidase and/or fatty acid oxidizing enzyme may be added to the textile as the only enzyme(s), or may be used in combination with one or more additional enzymes. The term “an additional enzyme” means at least one additional enzyme, e.g. one, two, three, four, five, six, seven, eight, nine, ten or even more additional enzymes. The additional enzyme may be an amylase or a lipase.

The fatty acid oxidizing enzyme used in accordance with the present invention may be applied together with an additional enzyme selected from the group consisting of: a proteolytic enzyme, such as a protease a lipolytic enzyme, a cellulolytic enzyme, such as a cellulase, a hemicellulase, an amylolytic enzyme, such as a amyloglucosidase, pectolytic enzyme, such as a pectinase, an oxidoreductase, e.g., a peroxidase, a laccase, a glucose oxidase, a pyranose oxidase, a lipooxygenase, and the like or mixtures hereof. In case of bleaching the textile an oxidase, such as carbohydrate oxidase; or a peroxidase may advantageously be present. In scouring processes of the invention a pectolytic enzyme, preferably a pectate lyase, may be used. Lipolytic enzymes, such as preferably cutinases and lipases, may be present during scouring. For desizing of textile, amylolytic enzymes, such as alpha-amylases, may be present.

The additional enzyme may be of any origin, including mammalian and plant, and preferably of microbial (bacterial, yeast or fungal) origin and may be derived by techniques conventionally used in the art. The term “derived” means in this context that the enzyme may have been isolated from an organism where it is present natively, i.e. the identity of the amino acid sequence of the enzyme are identical to a native enzyme. The term “derived” also means that the enzymes may have been produced recombinantly in a host organism, the recombinant produced enzyme having either an identity identical to a native enzyme or having a modified amino acid sequence, e.g. having one or more amino acids which are deleted, inserted and/or substituted, i.e., a recombinantly produced enzyme which is a mutant and/or a fragment of a native amino acid sequence or an enzyme produced by nucleic acid shuffling processes known in the art. Within the meaning of a native enzyme are included natural variants. Furthermore, the term “derived” includes enzymes produced synthetically by, e.g., peptide synthesis. The term “derived” also encompasses enzymes which have been modified e.g. by glycosylation, phosphorylation, or by other chemical modification, whether in vivo or in vitro. The term encompasses an enzyme that has been isolated from an organism where it is present natively, or one in which it has been expressed recombinantly in the same type of organism or another, or enzymes produced synthetically by, e.g., peptide synthesis. With respect to recombinantly produced enzymes the term “derived” refers to the identity of the enzyme and not the identity of the host organism in which it is produced recombinantly.

The enzymes may also be purified. The term “purified” as used herein covers enzymes free from other components from the organism from which it is derived. The term “purified” also covers enzymes free from components from the native organism from which it is derived. The enzymes may be purified, with only minor amounts of other proteins being present. The expression “other proteins” relate in particular to other enzymes. The term “purified” as used herein also refers to removal of other components, particularly other proteins and most particularly other enzymes present in the cell of origin of the enzyme of the invention. The enzyme may be “substantially pure,” that is, free from other components from the organism in which it is produced, that is, for example, a host organism for recombinantly produced enzymes. In preferred embodiment, the enzymes are at least 75% (w/w) pure, more preferably at least 80%, at least 85%, at least 90%, at least 95%, at least 96%, at least 97%, at least 98%, or at least 99% pure. In another preferred embodiment, the enzyme is 100% pure.

The enzyme may be in any form suited for the use in the treatment process, such as e.g. in the form of a dry powder or granulate, a non-dusting granulate, a liquid, a stabilized liquid, or a protected enzyme. Granulates may be produced, e.g. as disclosed in U.S. Pat. No. 4,106,991 and U.S. Pat. No. 4,661,452, and may optionally be coated by methods known in the art. Liquid enzyme preparations may, for instance, be stabilized by adding stabilizers such as a sugar, a sugar alcohol or another polyol, lactic acid or another organic acid according to established methods. Protected enzymes may be prepared according to the method disclosed in EP 238,216.

Some non-limiting examples of additional enzymes are listed below. The enzymes written in capitals are commercial enzymes available from Novozymes A/S, Krogshoejvej 36, DK-2880 Bagsvaerd, Denmark. The activity of any of those additional enzymes can be analyzed using any method known in the art for the enzyme in question, including the methods mentioned in the references cited.

Proteolytic Enzymes

Any proteolytic enzymes suitable for use in alkaline solutions can be used. Preferred are proteases including those of animal, vegetable or microbial origin. Microbial origin is preferred. Chemically or genetically modified mutants are included. The protease may be a serine protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described In WO 89/06279). Examples of trypsin-like proteases are trypsin (e.g. of porcine or bovine origin) and the Fusarium protease described in WO 89/06270. Other proteases are derived from Nocardiopsis, Aspergillus, Rhizopus, Bacillus alcalophilus, B. cereus, B. natto, B. vulgatus, B. mycoide, and subtilisins from Bacillus, especially proteases from the species Nocardiopsis sp. and Nocardiopsis dassonvillei such as those disclosed in WO 88103947, and mutants thereof, e.g. those disclosed in WO 91/00345 and EP 415296.

Preferred commercially available protease enzymes include those sold under the trade names ALCALASE™, SAVINASE™, PRIMASE™, NEUTRASE™, DURAZYM™, and ESPERASE™ by Novozymes A/S (Denmark), those sold under the tradename MAXATASE™, MAXACAL™, MAXAPEM™, PROPERASE™, PURAFECT™ and PURAFECT OXP™ by Genencor International, and those sold under the tradename OPTICLEAN™ and OPTIMASE™ by Solvay Enzymes. Protease enzymes may be incorporated into the compositions in accordance with the invention at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Lipolytic Enzymes

In the context of this invention lipolytic enzymes are classified in E.C. 3.1.1 and include true lipases, esterases, phospholipases, and lyso-phospholipases. More specifically the lipolytic enzyme may be a lipase as classified by EC 3.1.1.3, EC 3.1.1.23 and/or EC 3.1.1.26, an esterase as classified by EC 3.1.1.1, EC 3.1.1.2, EC 3.1.1.6, EC 3.1.1.7, and/or EC 3.1.1.8, a phospholipase as classified by EC 3.1.1.4 and/or EC 3.1.1.32, a lyso-phospholipase as classified by EC 3.1.1.5 and a cutinase as classified in EC 3.1.1.74.

The lipolytic enzyme preferably is of microbial origin, in particular of bacterial, of fungal or of yeast origin.

In a particular embodiment, the lipolytic enzyme used may be derived from a strain of Absidia, in particular Absidia blakesleena and Absidia corymbifera, a strain of Achromobacter, in particular Achromobacter iophagus, a strain of Aeromonas, a strain of Alternaria, in particular Alternaria brassiciola, a strain of Aspergillus, in particular Aspergillus niger and Aspergillus flavus, a strain of Achromobacter, in particular Achromobacter iophagus, a strain of Aureobasidium, in particular Aureobasidium pullulans, a strain of Bacillus, in particular Bacillus pumilus, Bacillus strearothermophilus and Bacillus subtilis, a strain of Beauvera, a strain of Brochothrix, in particular Bruchothrix thermosohata, a strain of Candida, In particular Candida cylindracea (Candida rugosa), Candida paralipolytica, Candida tsukubaensis, Candida auriculariae, Candida humicola, Cadida foliarum, Candida cylindracea (Cadida rugosa) and Candida antarctica, a strain of Chromobacter, in particular Chromobacter viscosum, a strain of Coprinus, in particular Coprinus cinerius, a strain of Fusarium, in particular Fusarium oxysporum, Fusarium solani, Fusarium solani pisi, and Fusarium roseum culmorum, a strain of Geotricum, in particular Geotricum penicillatum, a strain of Hansenula, in particular Hansenula anomala, a strain of Humicola, in particular Humicola brevispora, Humicula lanuginosa, Humicola brevis var. thermoidea, and Humicola insolens, a strain of Hyphozyma, a strain of Lactobacillus, in particular Lactobacillus curvatus, a strain of Metarhizium, a strain of Mucor, a strain of Paecilomyces, a strain of Penicillium, in particular Penicillium cyclopium, Penicillium crustosum and Penicillium expansum, a strain of Pseudomonas in particular Pseudomonas aeruginosa, Pseudomonas alcaligenes, Pseudomonas cepacia (syn. Burkholderia cepacia), Pseudomonas fluorescens, Pseudomonas fragi, Pseudomonas maltophilia, Pseudomonas mendocina, Pseudomonas mephitica lipolytica, Pseudomonas alcaligenes, Pseudomonas plantari, Pseudomonas pseudoalcaligenes, Pseudomonas putida, Pseudomonas stutzeri, and Pseudomonas wisconsinensis, a strain of Rhizoctonia, in particular Rhizoctonia solani, a strain of Rhizomucor, in particular Rhizomucor miehei, a strain of Rhizopus, in particular Rhizopus japonicus, Rhizopus microsporus and Rhizopus nodosus, a strain of Rhodosporidium, in particular Rhodosporidium toruloides, a strain of Rhodotorula, in particular Rhodotorula glutinis, a strain of Sporobolomyces, in particular Sporobolomyces shibatanus, a strain of Thermomyces, in particular Thermomyces lanuginosus (formerly Humicola lanuginosa), a strain of Thiarosporella, in particular Thiarosporella phaseolina, a strain of Trichoderma, in particular Trichoderma harzianum and Trichoderma reesei, and/or a strain of Verticillium.

In a more preferred embodiment, the lipolytic enzyme used according to the invention is derived from a strain of Aspergillus, a strain of Achromobacter, a strain of Bacillus, a strain of Candida, a strain of Chromobacter, a strain of Fusarium, a strain of Humicola, a strain of Hyphozyma, a strain of Pseudomonas, a strain of Rhizomucor, a strain of Rhizopus, or a strain of Thermomyces.

In a more preferred embodiment, the lipolytic enzyme used according to the invention is derived from a strain of Bacillus pumilus, a strain of Bacillus stearothermophilis a strain of Candida cylindracea, a strain of Candida antarctica, in particular Candida antarctica Lipase B (obtained as described in WO 88/02775), a strain of Humicola insolens, a strain of Hyphozyma, a strain of Pseudomonas cepacia, or a strain of Thermomyces lanuginosus.

In the context of this invention biopolyester hydrolytic enzyme include esterases and poly-hydroxyalkanoate depolymerases, in particular poly-3hydroxyalkanoate depolymerases. In fact an esterase is a lipolytic enzyme as well as a biopolyester hydrolytic enzyme.

In a more preferred embodiment, the esterase is a cutinase or a suberinase. Also in the context of this invention, a cutinase is an enzyme capable of degrading cutin, cf. e.g. Lin T S & Kolattukudy P E, J. Bacteriol. 1978 133 (2) 942-951, a suberinase is an enzyme capable of degrading suberin, cf. e.g., Kolattukudy P E; Science 1980 208 990-1000, Lin T S & Kolattukudy P E; Physiol. Plant Pathol. 1980 17 1-15, and The Biochemistry of Plants, Academic Press, 1980 Vol. 4 624-634, and a poly-3-hydroxyalkanoate depolymerase is an enzyme capable of degrading poly-3-hydroxyalkanoate, cf. e.g. Foster et al., FEMS Microbiol. Lett. 1994 118 279-282. Cutinases, for instance, differs from classical lipases in that no measurable activation around the critical micelle concentration (CMC) of the tributyrine substrate is observed. Also, cutinases are considered belonging to a class of serine esterases. The cutinase may also be a cutinase derived from Humicola insolens disclosed in WO 96/13580. The cutinase may be a variant such as one or the variants disclosed in WO 00/34450 and WO 01/92502 which is hereby incorporated by reference.

The biopolyester hydrolytic enzyme preferably is of microbial origin, in particular of bacterial, of fungal or of yeast origin.

In a preferred embodiment, the biopolyester hydrolytic enzyme is derived from a strain of Aspergillus, in particular Aspergillus oryzae, a strain of Alternaria, in particular Alternaria brassiciola, a strain of Fusarium, in particular Fusarium solani, Fusarium solani pisi, Fusarium roseum culmorum, or Fusarium roseum sambuciumi, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, or a strain of Ulocladium, in particular Ulocladium consortiale. In a most preferred embodiment the biopolyester hydrolytic enzyme is a cutinase derived from a strain of Humicola insolens, in particular the strain Humicola insolens DSM 1800.

In another preferred embodiment, the poly-3-hydroxyalkanoate depolymerase is derived from a strain of Alcaligenes, in particular Alcaligenes faecalis, a strain of Bacillus, in particular Bacillus megaterium, a strain of Camomonas, in particular Camomonas testosteroni, a strain of Penicillium, in particular Penicillium funiculosum, a strain of Pseudomonas, in particular Pseudomonas fluorescens, Pseudomonas lemoignei and Pseudomonas oleovorans, or a strain of Rhodospirillum, in particular Thodospirillum rubrum.

Specific examples of readily available commercial lipases include LIPOLASE™ (WO 98/35026) LIPOLASE™ Ultra, LIPOZYME™, PALATASE™, NOVOZYM™ 435, LECITASE™ (all available from Novozymes A/S, Denmark).

Examples of other lipases are LUMAFAST™, Ps. mendocian lipase from Genencor Int. Inc.; LIPOMAX™, Ps. pseudoalcaligenes lipase from Gist Brocades/Genenoor mnt. Inc.; Fusarium solani lipase (cutinase) from Unilever; Bacillus sp. lipase from Solvay enzymes. Other lipases are available from other companies.

Examples of cutinases are those derived from Humicola insolens (U.S. Pat. No. 5,827,719); from a strain of Fusadum, e.g. F. roseum culmorum, or particularly F. solani pisi (WO 90/09446; WO 94/14964, WO 94/03578). The cutinase may also be derived from a strain of Rhizoctonia, e.g. R. solani, or a strain of Alternaria, e.g. A. brassicicola (WO 94/03578), or variants thereof such as those described in WO 00/34450, or WO 01/92502.

Pectolytic Enzymes

The term “pectolytic enzyme” or “pectinase” as denoted herein, is intended to include any pectinase enzyme defined according to the art where pectinases are a group of enzymes that hydrolyse glycosidic linkages of pectic substances mainly poly-1,4-a-D-galacturonide and its derivatives(see reference Sakai et al., Pectin, pectinase and propectinase: production, properties and applications, pp 213-294 in: Advances in Applied Microbiology vol: 39,1993) which enzyme is understood to include a mature protein or a precursor form thereof or a functional fragment thereof which essentially has the activity of the full-length enzyme. Furthermore, the term “pectolytic” enzyme is intended to include homologues or analogues of such enzymes.

Preferably a pectolytic enzyme useful in the method of the invention is a pectinase enzyme which catalyzes the random cleavage of alpha-1,4-glycosidic linkages in pectic acid also called polygalacturonic acid by transelimination such as the enzyme class polygalacturonate lyase (EC 4.2.2.2) (PGL) also known as poly(1,4-a-D-galacturonide)lyase also known as pectate lyase. Also preferred is a pectinase enzyme which catalyzes the random hydrolysis of alpha-1,4-glycosidic linkages in pectic acid such as the enzyme class polygalacturonase (EC 3.2.1.15) (PG) also known as endo-PG. Also preferred is a pectinase enzyme such as polymethylgalcturonate lyase (EC 4.2.2.10) (PMGL), also known as Endo-PMGL, also known as poly(methyoxygalacturonide)lyase also known as pectin lyase which catalyzes the random cleavage of alpha-1,4-glycosidic linkages of pectin. Other preferred pectinases are galactanases (EC 3.2.1.89), arabinanases (EC 3.2.1.99), pectin esterases (EC 3.1.1.1.1), and mannanases (EC 3.2.1.78).

The enzyme Is preferably derived from a microorganism, preferably from a bacterium, an archea or a fungus, especially from a bacterium such as a bacterium belonging to Bacillus, preferably to an alkalophilic Bacillus strain which may be selected from the group consisting of the species Bacillus licheniformis and highly related Bacillus species in which all species are at least 90% homologous to Bacillus licheniformis based on aligned 16S rDNA sequences. Specific examples of such species are the species Bacillus licheniformis, Bacillus alcalophilus, Bacillus pseudoalcalophilus, and Bacillus clarkii. A specific and highly preferred example is the species Bacillus licheniformis, ATCC 14580. Other useful pectate lyases are derivable from the species Bacillus agaradhaerens, especially from the strain deposited as NCIMB 40482; and from the species Aspergillus aculeatus, especially the strain and the enzyme disclosed in WO 94/14952 and WO 94/21786 which are hereby incorporated by reference in their entirety; and from the species Bacillus subtilis, Bacillus stearothermophilus, Bacillus pumilus, Bacillus cohnii, Bacillus pseudoalcalophilus, Erwinia sp. 9482, especially the strain FERM BP-5994, and Paenibacillus polymyxa.

The pectolytic enzyme may be a component occurring in an enzyme system produced by a given microorganism, such an enzyme system mostly comprising several different pectolytic enzyme components including those identified above.

Alternatively, the pectolytic enzyme may be a single component, i.e. a component essentially free of other pectinase enzymes which may occur in an enzyme system produced by a given microorganism, the single component typically being a recombinant component, i.e. produced by cloning of a DNA sequence encoding the single component and subsequent cell transformed with the DNA sequence and expressed in a host. Such useful recombinant enzymes, especially pectate lyases, pectin lyases and polygalacturonases are described in detail in e.g. WO 99/27083 and WO 99/27084 (from Novozymes A/S) which are hereby incorporated by reference in their entirety including the sequence listings. The host is preferably a heterologous host, but the host may under certain conditions also be the homologous host.

In a preferred embodiment the pectate lyase used according to the invention is derived from the genus Bacillus, preferably the species Bacillus licheniformis.

The pectate lyase is normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Commercially available products include BIOPREP™ from Novozymes A/S, Denmark.

Amylolytic Enzymes

Preferred amylolytic enzymes are amylases. Any amylase (alpha and/or beta) suitable for use in alkaline solutions can be used. Suitable amylases include those of bacterial or fungal origin. Chemically or genetically modified mutants are included. Amylases include, for example, alpha-amylases obtained from a special strain of B. licheniformis, described in more detail in GB 1,296,839. Commercially available amylases are DURAMYL™, NATALASE™, TERMAMYL™, STAINZYME™, AQUAZYM™, and AQUAZYM™ Ultra, FUNGAMYL™ and BAN™ (available from Novozymes A/S) and RAPIDASE™ and MAXAMYL P™ (available from Genencor Int., USA).

The amylase(s) is(are) normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Cellulolytic Enzyme

In the present context, the term “cellulase or “cellulolytic enzyme” refers to an enzyme which catalyzes the degradation of cellulose to glucose, cellobiose, triose and other cellooligosaccharides. Cellulose is a polymer of glucose linked by beta-1,4-glucosidic bonds. Cellulose chains form numerous intra- and intermolecular hydrogen bonds, which result in the formation of insoluble cellulose microfibrils. Microbial hydrolysis of cellulose to glucose involves the following three major classes of cellulases: endo-1,4-beta-glucanases (EC 3.2.1.4), which cleave beta-1,4-glucosidic links randomly throughout cellulose molecules; cellobiohydrolases (EC 3.2.1.91)(exoglucanases), which digest cellulose from the nonreducing end; and beta-glucosidases (EC 3.2.1.21), which hydrolyse cellobiose and low-molecular-mass cellodextrins to release glucose. Most cellulases consist of a cellulose-binding domain (CBD) and a catalytic domain (CAD) separated by a linker rich in proline and hydroxy amino acid residues. In the specification and claims, the term “endoglucanase” is intended to denote enzymes with cellulolytic activity, especially endo-1,4-beta-glucanase activity, which are classified in EC 3.2.1.4 according to the Enzyme Nomenclature (1992) and are capable of catalysing (endo)hydrolysis of 1,4-beta-D-glucosidic linkages in cellulose, lichenin and cereal beta-D-glucans including 1,4-linkages in beta-D-glucans also containing 1,3-linkages. Any cellulase suitable for use in alkaline solutions can be used. Suitable cellulases include those of bacterial or fungal origin. Chemically or genetically modified mutants are included. Suitable cellulases are disclosed in U.S. Pat. No. 4,435,307, which discloses fungal cellulases produced from Humicola insolens. Especially suitable cellulases are the cellulases having colour care benefits. Examples of such cellulases are cellulases described in European patent application No. 0 495 257, WO 91/17243 and WO 96/29397.

Commercially available cellulases include CELLUZYME™ and DENIMAX™ produced by a strain of Humicola insolens (Novozymes A/S), and KAC500(B)™ (Kao Corporation).

Cellulases are normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Peroxidases/Oxidases

Peroxidase enzymes are used in combination with hydrogen peroxide or a source thereof (e.g. a percarbonate, perborate or persulfate). Oxidase enzymes are used in combination with oxygen. Both types of enzymes are used for “solution bleaching”, i.e. to prevent transfer of a textile dye from a dyed fabric to another fabric when said fabrics are washed together in a wash liquor, preferably together with an enhancing agent as described in e.g. WO 94/12621 and WO 95/01426. Suitable peroxidases/oxidases include those of plant, bacterial or fungal origin. Chemically or genetically modified mutants are included.

Peroxidase and/or oxidase enzymes are normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Mixtures of the above mentioned enzymes are encompassed herein, in particular a mixture of a protease, an amylase, a lipase and/or a cellulase.

The enzyme of the invention, or any other enzyme incorporated in the composition, is normally incorporated in the composition at a level from 0.00001% to 2% of enzyme protein by weight of the composition, preferably at a level from 0.0001% to 1% of enzyme protein by weight of the composition, more preferably at a level from 0.001% to 0.5% of enzyme protein by weight of the composition, even more preferably at a level from 0.01% to 0.2% of enzyme protein by weight of the composition.

Bleach Activator

Any suitable bleach activator may be employed in the present invention. The bleach activators preferred for use in accordance with the invention, include, for example, compounds of the following classes of substances: Polyacylated sugars or sugar derivatives with C sub 1-10-acyl radicals, preferably acetyl, propionyl, octanoyl, nonanoyl or benzoyl radicals, particularly preferably acetyl radicals, can be used as bleach activators. Sugars or sugar derivatives which can be used are mono- or disaccharides and their reduced or oxidized derivatives, preferably glucose, mannose, fructose, sucrose, xylose or lactose. Particularly suitable bleach activators of this class of substances are, for example, pentaacetylglucose, xylose tetraacetate, 1-benzoyl-2,3,4,6-tetraacetylglucose and 1-octanoyl-2,3,4,6-tetraacetylglucose.

Another class of substances which are preferred for use as bleach activators in the present invention comprises acyloxybenzenesulfonic acids and their alkali metal and alkaline earth metal salts, such as C sub 1-14-acyl radicals. Acetyl, propionyl, octanoyl, nonanoyl and benzoyl radicals are preferred, especially acetyl radicals and nonanoyl radicals. Particularly suitable bleach activators in this class of substances are acetyloxybenzenesulfonic acid and benzoyloxybenzenesulfonic acid. They are preferably employed in the form of their sodium salts.

Other bleach activators for use in the present invention include MMA and OCL, alone or in combination with each other or with TAED; O-acyloxime esters, such as acetone O-acetyloxime, acetone O-benzoyloxime, bis(propylimino)carbonate, bis(cyclohexylimino)carbonate as a bleach activator. Acylated oximes which can be used as a bleach activator according to the invention are described, for example, in EP-A-0 028 432. Oxime esters which can be used as a bleach activator according to the invention are described, for example in EP-A-0 267 046.

Additional preferred bleach activators include N-acylcaprolactams, such as N-acetylcaprolactam, N-benzoylcaprolactam, N-octanoylcaprolactam and carbonylbiscaprolactam; N,N-diacylated and N,N,N′,N′-tetraacylated amines, such as N,N,N′,N′-tetraacetylmethylenediamine and -ethylenediamine (TAED), N,N-diacetylaniline, N,N-diacetyl-p-toluidine or 1,3diacylated hydantoins such as 1,3-diacetyl-5,5-dimethylhydantoin; N-alkyl-N-sulfonylcarboxamides, such as N-methyl-N-mesylacetamide or N-methyl-N-mesylbenzamide; N-acylated cyclic hydrazides, acylated triazoles or urazoles, such as monoacetylated maleic hydrazide; O,N,N-trisubstituted hydroxylamines, such as O-benzoyl-N,N-succinyl-hydroxylamine, O-acetyl-N,N,N-succinylhydroxylamine or O,N,N-triacetylhydroxylamine; N,N′-diacylsulfamides, such as N,N′-dimethyl-N,N′-diacetylsulfamide or N,N′-diethyl-N,N′-diproplonylsulfamide; triacylcyanurates, such as triacetylcyanurate or tribenzoylcyanurate; carboxylic anhydrides, such as benzoic anhydride, m-chlorobenzoic anhydride or phthalic anhydride; 1,3-diacyl-4,5-diacyloxyimidazolines, such as 1,3-diacetyl-4,5-diacetoxyimidazoline; tetraacetylglycoluril and tetrapropionylglycoluril; diacylated 2,5-diketopiperazines, such as 1,4-diacetyl-2,5-diketopiperazine; acylation products of propylenediurea and 2,2-dimethylpropylenediurea, such as tetraacetylpropylenediurea; alpha.-acyloxypolyacylmalonamides, such as .alpha.-acetoxy-N,N′-diacetylmalonamide; diacyldioxohexahydro-1,3,5-triazines, such as 1,5-diacetyl-2,4dioxohexahydro-1,3,5-triazine; 2-alkyl- or 2-aryl-(4H)-3,1-benzoxazin-4-ones as described, for example, in EP-B1-0 332 294 and EP-B 0 502 013, and 2-phenyl-(4H)-3,1-benzoxazin-4-one and 2-methyl-(4H)-3,1-benzoxazin-4-one, cationic nitrites, as described, for example, in EP 303 520 and EP 458 396 A1, such as, methosulfates or tosylates of trimethylammonioacetonitrile, N,N-dimethyl-N-octylammonioacetonitrile, 2-(trimethylammonio)propionitrile, 2-(trimethylammonio)-2-methylpropionitrile. Also suitable are the methosulfates of N-methylpiperazinio-N,N′-diacetonitrile and N-methylmorpholinioacetonitrile (MMA).

Additional bleach activators for use in the present invention include percarbamic acids or diacyl percarbamates and precursors thereof, as disclosed, e.g., in WO 02/16538 hereby incorporated by reference.

Bleach activators are typically added in an amount from about 0.1 to 30 g/l, more preferably 0.5 to 10 g/l.

Bleach Stabilizer

In another preferred embodiment of the present invention, the bleaching system additionally contains one or more bleach stabilizers. The bleach stabilizers comprise additives able to adsorb, bind or complex traces of heavy metals. Examples of additives which can be used according to the invention with a bleach-stabilizing action are polyanionic compounds, such as polyphosphates, polycarboxylates, polyhydroxypolycarboxylates, soluble silicates as completely or partially neutralized alkali metal or alkaline earth metal salts, in particular as neutral Na or Mg salts, which are relatively weak bleach stabilizers. Examples of strong bleach stabilizers which can be used according to the invention are complexing agents such as ethylenediaminetetraacetate (EDTA), diethylenetriaminepentaacetic acid (DTPA), nitrilotriacetic acid (NTA), methyl-glycinediacetic acid (MGDA), .beta.-alaninediacetic acid (ADA), ethylenediamine-N,N′-disuccinate (EDDS) and phosphonates such as ethylenediaminetetramethylenephosphonate, diethylenetriaminepentamethylenephosphonate (DTMPA) or hydroxyethylidene-1,1-diphosphonic add in the form of the acids or as partially or completely neutralized alkali metal salts.

The bleach stabilizer is typically added to the treating composition in an amount from about 0.1 to about 5/g liter of the composition, more preferably from about 0.5 to about 2 g/l, and most preferably about 1 g/l.

Adjuvants

The method of the invention may be carried out in the presence of conventional textile adjuvants, including fabric, fiber, or yarn finishing agents, including wetting agents, such as certain surfactants; polymeric agents; dispersing agents, etc.

Wetting Agents

A conventional wetting agent may be used to improve the contact between the substrate and the enzyme used in the method. The wetting agent may be a nonionic surfactant, e.g. an ethoxylated fatty alcohol. A preferred wetting agent is an ethoxylated and propoxylated fatty acid ester such as Berol 087 (product of Akzo Nobel, Sweden). In an embodiment the method of the invention is carried out in the presence of a surfactant. Preferred surfactants are nonionic, non-linear surfactants. The term “nonionic” is well defined in the literature and generally refers to surfactants that do not possess ionizable functional groups. In the context of the present invention, the term “non-linear” is defined as a surfactant whose hydrophobic portion of the molecular structure is of a branched origin and possesses chain branching. Chain branching is defined in the context of the present invention as a molecular structure possessing one or more carbon atoms directly bonded to more than two carbon atoms or whose hydrophobic portion is derived from a secondary or tertiary alcohol. Polyethylene, polypropylene, and polybutylene oxide condensates of alkyl phenols are suitable for use as the nonionic, non-linear surfactant of the surfactant systems of the present invention, with the polyethylene oxide condensates being preferred. These compounds include the condensation products of alkyl phenols having an alkyl group containing from about 6 to about 14 carbon atoms, preferably from about 8 to about 14 carbon atoms, in either a straight chain or branched-chain configuration. In a preferred embodiment, the ethylene oxide is present in an amount equal to from about 2 to about 25 moles, more preferably from about 3 to about 15 moles, of ethylene oxide per mole of alkyl phenol. Commercially available nonionic, nonlinear surfactants of this type include Igepal™ CO-630, marketed by the GAF Corporation, Triton™ X-45, X-114, X-100 and X-102, and Terginol NP, preferably Terginol NP9 all marketed by DOW/Union Carbide. These surfactants are commonly referred to as alkylphenol alkoxylates (e.g., alkyl phenol ethoxylates).

The condensation products of secondary aliphatic alcohols with about 1 to about 25 moles of ethylene oxide are suitable for use as the nonionic surfactant of the nonionic surfactant systems of the present invention. The alkyl chain of the aliphatic alcohol generally contains from about 8 to about 22 carbon atoms. Preferred are the condensation products of alcohols having an alkyl group containing from about 8 to about 20 carbon atoms, more preferably from about 10 to about 18 carbon atoms, with from about 2 to about 15 moles of ethylene oxide per mole of alcohol, preferably about 5 to about 15 moles of ethylene oxide and most preferably from about 7 to about 13 moles of ethylene oxide per mole of alcohol. Examples of commercially available nonionic surfactants of this type include Terginol™ 15-S-9 (the condensation product of C₁₁-C₁₅ secondary alcohol with 9 moles ethylene oxide), Terginol™ 15-S-12 and Softanol 90. Preferred range of HLB in these products is from 8-15 and most preferred from 10-14. The condensation products of secondary aliphatic alcohols with about 1 to about 25 moles of ethylene oxide are suitable for use as the nonionic surfactant of the nonionic surfactant systems of the present invention. The alkyl chain of the aliphatic alcohol generally contains from about 8 to about 22 carbon atoms. Preferred are the condensation products of alcohols having an alkyl group containing from about 8 to about 20 carbon atoms, more preferably from about 10 to about 18 carbon atoms, with from about 2 to about 15 moles of ethylene oxide per mole of alcohol, preferably about 5 to about 15 moles of ethylene oxide and most preferably from about 7 to about 13 moles-of ethylene oxide per mole of alcohol. Examples of commercially available nonionic surfactants of this type include Terginol™ 15-S-9 (the condensation product of C₁₁-C₁₅ secondary alcohol with 9 moles ethylene oxide), Terginol™ 15-S-12 and Softanol 90. Preferred range of HLB in these products is from 8-15 and most preferred from 10-14.

Also useful as the nonionic surfactant of the surfactant systems of the present invention are the condensation products of styrenated phenolics with ethylene oxide. In a preferred embodiment, the ethylene oxide is present in an amount equal to from about 2 to about 25 moles, more preferably from about 9 to about 15 moles, of ethylene oxide per mole of styrenated phenol. Examples of commercially available styrenated phenols of this type are Ethox 2622, Ethox 2659 and Ethox 2938.

The condensation products of branched aliphatic alcohols such as tridecylalcohol with about 1 to about 25 moles of ethylene oxide are suitable for use as the nonionic surfactant of the nonionic surfactant systems of the present invention. Commercially available examples of this surfactant class are Novell II TDA6.6, Novell II TDA-7, Novell II TDA8.5, Novell II TDA-9, Novell II TDA-9.5 and Novell II TDA-11.

Polymeric Agents

Examples of suitable polymeric agents Include proteins (e.g. bovine serum albumin, whey, casein or legume proteins), protein hydrolysates (e.g. whey, casein or soy protein hydrolysate), polypeptides, lignosulfonates, polysaccharides and derivatives thereof, polyethylene glycol, polypropylene glycol, polyvinyl pyrrolidone, ethylene diamine condensed with ethylene or propylene oxide, ethoxylated polyamines, or ethoxylated amine polymers.

Dispersing Agents

The dispersing agent may preferably be selected from nonionic, anionic, cationic, ampholytic or zwitterionic surfactants. More specifically, the dispersing agent may be selected from carboxymethylcellulose, hydroxypropylcellulose, alkyl aryl sulphonates, long-chain alcohol sulphates (primary and secondary alkyl sulphates), sulphonated olefins, sulphated monoglycerides, sulphated ethers, sulphosuccinates, sulphonated methyl ethers, alkane sulphonates, phosphate esters, alkyl isothionates, acylsarcosides, alkyltaurides, fluorosurfactants, fatty alcohol and alkylphenol condensates, fatty acid condensates, condensates of ethylene oxide with an amine, condensates of ethylene oxide with an amide, sucrose esters, sorbitan esters, alkyloamides, fatty amine oxides, ethoxylated monoamines, ethoxylated diamines, alcohol ethoxylate and mixtures thereof. A preferred. dispersing agent is an alcohol ethoxylate such as Berol 08 (product of Akzo Nobel, Sweden).

The textile may be further finished by one or more of the following treatments as are known in the art: dyeing, biopolishing, brightening, softening, and/or anti-wrinkling treatment(s).

Composition

In a final aspect the invention relates to a composition comprising a fatty acid oxidizing enzyme and in addition thereto at least one adjuvant.

In a preferred embodiment the adjuvant is selected from the group consisting of wetting agent, polymeric agent, and dispersing agent.

The fatty acid oxidizing enzyme may be any of the above mentioned. Preferred fatty acid oxidizing enzymes are lipoxygenases, especially the above mentioned derived from the genus Magnaporthe, especially a strain of Magnaporthe salvinii.

The composition of the invention may in a preferred embodiment further comprising an enzyme selected from the group consisting of: a proteolytic enzyme, a lipolyuc enzyme, a cellulolytic enzyme, an amylolytic enzyme, a pectolytic enzyme, an oxidase enzyme, or a peroxidase enzyme, or mixtures hereof. Preferred additional enzymes are cutinases, amylases and pectate lyases.

The invention is further illustrated in the following examples, which are not intended to be in any way limiting to the scope of the invention as claimed.

Materials and Methods

Materials:

Enzymes

Microdochium nivale carbohydrate oxidase, expressed and purified from Fusarium venenatum (U.S. Pat. No. 6,165,761).

Fatty acid oxidizing enzyme: Lipoxygenase from Magnaporthe salvinii was cloned and expressed in Aspergillus oryzae as described in Example 2 of WO 02/086114.

Pectate lyase: Bioprep 3000L (batch KND00007, 3000 APSU/g) available from Novozymes A/S, Denmark.

Cutinase: (2002-00081, 17.2 KLU/g) is disclosed in WO 01/92502 and is derived from the wild-type cutinase of Humicola insolens DSM 1800 comprising the following 12 mutations: E6Q, G8D, A14P, N15D, E47K, S48E, R51P, A88H, N91H, A130V, E179Q and R189V and is available from Novozymes A/S, Denmark.

AQUAZYM™ ULTRA is an alpha-amylase available from Novozymes A/S, Denmark.

Na₂HPO₄ 7H₂O (F. W. 268.07, US-0001-10) was purchased from Fisher Scientific.

Na₂B₄O₇ 10H₂O (F.W. 381.37, US-0064-11) was purchased from Aldrich.

Na₂CO₃ H₂O was purchased from Aldrich.

Kieralon Jet B is a mixture of nonionic surfactants purchased from BASF.

Linoleic acid (99%, batch 71k2050) was purchased from SIGMA (USA).

Linoleic acid (L-1376, lot 61K1147) was purchased from SIGMA (USA).

Linolenic acid (L-2376, lot 072K1228) was purchased from SIGMA (USA).

Medium and Substrates

Surfactant Kierlon Jet B available from BASF.

Na-phosphate buffer pH 7.0. Prepared by mixing 20 mM NaH₂PO₄ and 1 N NaOH.

D-arabinose: Aldrich

D-xylose: Aldrich

D-alpha-glucose: Sigma-Aldrich (Cat. 15,896-8)

D-beta-glucose: SIGMA (G-5250)

D-galactose: Sigma (G-065)

D-fructose: Sigma (F2543)

D-mannose: Fisher Scientific (M-12175767)

D-cellobiose: Sigma-Aldrich(C-7252)

D-maltose: Sigma (M9171)

D-beta-lactose: Sigma (L-3750)

Maltotriose: Sigma (M-8378)

Dextrin: Sigma (75%, type III, from corn)

Sodium hydroxide available from Fisher Scientific Co.

Equipment

MacBeth Color Eye equipped with Optiview 7000 software.

Labomat (Mathis)

Methods

Whiteness index (WI) was calculated from the following equation:
WI=Y+800(xₙ−x)+1700(yₙ−y)
where Y, x and y are chromaticity coordinates of the sample, and xₙ and yₙ are those of illuminant using the standard illuminant D65. The water absorbency of the swatches was determined according to AATCC method 79 (Technical Manual of the American Association of Textile Chemists and Colorists).
Carbohydrate Oxidase Activity (COXU)

A Carbohydrate Oxidase unit (COXU is defined as the amount of enzyme that oxidizes one micromol lactose per minute under the following conditions:

| | |
|---|---|
| Buffer | 100 mm phosphate - 100 mm citrate |
| pH | 6.0 |
| carbohydrate oxidase | 0.2-1 micro g enzyme/ml |
| lactose | 4.3 mm |
| 4-aminoantipyrine {AA} | 1.7 mm |
| n-ethyl-n-sulfopropyl-m- | 4.3 mm |
| toluidine {TOPS} | |
| peroxidase, sigma | 2.1 U/mL |
| temperature | 37° C. |
| time | 4.17 minutes |
| wavelength | 550 nm |

Here is one COXU defined as one mg of pure carbohydrate oxidase enzyme—relative to an enzyme standard. carbohydrate oxidase acts in the presence of o₂ on lactose to form lactobionic acid and H₂O₂. The formed H₂O₂ activates in the presence of peroxidase the oxidative condensation of 4-aminoantipyrine {AA} and n-ethyl-n-sulfopropyl-m-toluidine {TOPS}, to form a purple product which can be quantified by its absorbance at 550 nm. When all components but carbohydrate oxidase are in surplus, the rate of the rising absorbance is proportional to the COXU, carbohydrate oxidase activity present. The reaction proceeds automatically in the Cobas Fara centrifugal analyzer.

Lipoxygenase Activity (LOX Units)

The lipoxygenase activity was measured according to Novozymes; Standard Method 2001-21910-03 hereby incorporated by reference and available from Novozyme A/S, Denmark, on request One LOX unit causes an increase in A₂₃₄ of 0.001 per minute at ph 9.0 at 30° C., when linoleic acid is used as substrate. Reaction volume=1.0 ml (1 cm light path).

Cutinase Activity (LU)

The cutinase activity is determined as lipolytic activity determined using tributyrine as substrate. This method was based on the hydrolysis of tributyrin by the enzyme, and the alkali consumption is registered as a function of time. One Lipase Unit (LU) is defined as the amount of enzyme which, under standard conditions (i.e. at 30.0° C.; pH 7.0; with Gum Arabic as emulsifier and tributyrine as substrate) liberates 1 micromol titrable butyric acid per minute. A folder AF 95/5 describing this analytical method in more detail is available upon request to Novozymes A/S, Denmark, which folder is hereby included by reference.

Determination of Pectate Lyase Activity

The Viscosity Assay APSU

APSU units: The APSU unit assay is a viscosity measurement using the substrate polygalacturonic acid with no added calcium.

The substrate 5% polygalacturonic acid sodium salt (Sigma P-1879) is solubilised in 0.1 M Glycin buffer pH 10. The 4 ml substrate is preincubated for 5 min at 40° C. The enzyme is added (in a volume of 250 microliters) and mixed for 10 sec on a mixer at maximum speed, it is then incubated for 20 min at 40° C. For a standard curve double determination of a dilution of enzyme concentration in the range of 5 APSU/ml to above 100 APSU/ml with minimum of 4 concentrations between 10 and 60 APSU per ml.

The viscosity is measured using a MIVI 600 from the company Sofraser, 45700 Villemandeur, France. The viscosity is measured as mV after 10 sec.

For calculation of APSU units a enzyme standard dilution as described above was used for obtaining a standard curve. The GrafPad Prism program, using a non linear fit with a one phase exponential decay with a plateau, was used for calculations. The plateau plus span is the mV obtained without enzyme. The plateau is the mV of more than 100 APSU and the half reduction of viscosity in both examples was found to be 12 APSU units with a standard error of 1.5 APSU.

The Lyase Assay (at 235 nm)

For determination of the β-elimination an assay measuring the increase in absorbance at 235 nm was carried out using the substrate 0.1% polygalacturonic acid sodium salt (Sigma P-1879) solubilized in 0.1 M Glycin buffer pH 10. For calculation of the catalytic rate an increase of 5.2 Absorbency at 235 units per min corresponds to formation of 1 micro-mol of unsaturated product (Nasuna and Starr (1966) J. Biol. Chem. Vol 241 page 5298-5306; and Bartling, Wegener and Olsen (1995) Microbiology Vol 141 page 873-881).

Steady state condition using a 0.5 ml cuvette with a 1 cm light; path on a HP diode array spectrophotometer in a temperature controlled cuvette holder with continuous measurement of the absorbency at 235 nm. For steady state a linear increase for at least 200 sec was used for calculation of the rate. It was used for converted to formation μmol per min product.

Determination of Cellulase Activity (ECU)

The cellulolytic activity may be determined in endo-cellulase units (ECU) by measuring the ability of the enzyme to reduce the viscosity of a solution of carboxy methyl cellulose (CMC).

The ECU assay quantifies the amount of catalytic activity present in the sample by measuring the ability of the sample to reduce the viscosity of a solution of carboxy-methylcellulose (CMC). The assay is carried out in a vibration viscosimeter (e.g. MIVI 3000 from Sofraser, France) at 40° C.; pH 7.5; 0.1 M phosphate buffer; time 30 min; using a relative enzyme standard for reducing the viscosity of the CMC substrate(Hercules 7 LFD), enzyme concentration approx. 0.15 ECU/ml. The arch standard is defined to 8200 ECU/g.

One ECU is amount of enzyme that reduces the viscosity to one half under these conditions.

### EXAMPLES

### Example 1

### Effect of Glucose, Carbohydrate Oxidase and NaOH in Cotton Bleaching

Peroxide generation and bleaching was conducted in Labomat (Mathis). Typically, about 140 ml sodium phosphate buffer, 0.5 g/l Kierlon Jet B, alpha-glucose and carbohydrate oxidase were added to a 1 liter beaker, containing two fabric swatches about 14 g total weight of cotton knit (Ramseur). All beakers were incubated at 40° C. for 4 hours to generate peroxide. Sodium hydroxide was added and the beaker temperature was raised to 95° C. After 60 minutes incubation, all beakers were cooled to 80° C. Cotton swatches were taken out and the liquor pH in the beaker was measured. Cotton swatches were rinsed in hot (50° C.) and cold water for 10 minutes prior to air drying. All beakers were constantly rotated at 50 rpm.

After cotton swatches were equilibrated in a constant temperature and humidity (70° F., 65% RH) for at least 24 hours, the value of whiteness index (WI) was measured using MacBeth Color Eye.

Results are shown in Table 1 below. Cotton swatches in four beakers have different whiteness index. Glucose alone reduces cotton fabric whiteness. Carbohydrate oxidase and sodium hydroxide improve cotton whiteness.

TABLE 1

| | Peroxide generation | | | | | |
|---|---|---|---|---|---|---|
| Sam- | Carbohydrate | | Bleaching | | | |
| ple | Oxidase | Glucose | NaOH | Final | CIE | Absorbency |
| # | (U/ml) | (g/l) | (g/l) | pH | WI | (second) |
| S1 | 0 | 0 | 0 | 7.0 | 26.46 | <1 |
| S2 | 0 | 5 | 0 | 6.9 | 24.86 | N/A* |
| S3 | 0 | 5 | 0.5 | 7.4 | 26.22 | <1 |
| S4 | 1.5 | 5 | 0.5 | 6.6 | 33.20 | <1 |

*N/A: not measured.

### Example 2

### Effect of Peroxide Generation Time, Glucose and Carbohydrate Oxidase on Fabric Properties

All materials and chemicals were essentially the same as in Example 1. The peroxide generation and bleach experimental were the same as in Example 1 except that the time, the amount of Carbohydrate Oxidase and glucose varied during peroxide generation, the concentration of sodium hydroxide was kept at 3 g/l. The value of whiteness index and absorbency of cotton fabric were measured using the same methods in Example 1. After bleaching, liquor pH was measured and liquor color was also observed and recorded.

Table 2 shows the value of whiteness index and absorbency results. Statistic analysis indicated that Carbohydrate Oxidase and time are statistically significant. Increasing carbohydrate oxidase (from 0.5 U/ml to 1.5 U/ml) enhanced whiteness by 6 units. Higher pH in the bleaching step appeared promoting the bleaching performance.

TABLE 2
Impact of time and Carbohydrate Oxidase on fabric properties

| | Peroxide generation | | | | | | | |
|---|---|---|---|---|---|---|---|---|
| | | | Carbohydrate | Bleaching | | Final | | |
| | Time | Glucose | Oxidase | NaOH | Final | Liquor | CIE | Absorbency |
| Sample # | (min) | (g/l) | (U/ml) | (g/l) | pH | color | WI | (second) |
| S1 | 60 | 5 | 0.5 | 3 | 10.11 | Light | 30.49 | <1 |
| | | | | | | brown | | |
| S2 | 60 | 5 | 1.5 | 3 | 11.13 | Light | 36.46 | <1 |
| | | | | | | brown | | |
| S3 | 240 | 5 | 0.5 | 3 | 10.32 | Light | 32.08 | <1 |
| | | | | | | brown | | |
| S4 | 240 | 5 | 1.5 | 3 | 11.20 | Light | 38.26 | <1 |
| | | | | | | brown | | |

### Example 3

### Effect of NaOH on Whiteness and Water Absorbency

All materials and chemicals were essentially the same as in Example 1. The peroxide generation and bleach experimental were the same as in Example 1 except that the amount of Carbohydrate Oxidase, glucose and sodium hydroxide varied. The value of whiteness index and absorbency of cotton fabric were measured using the same methods in Example 1.

Table 3 shows the value of whiteness index and absorbency results. Higher absorbency is indicated by lower wetting time. Sodium hydroxide has a positive impact on water absorbency. Increasing the concentrations of carbohydrate oxidase and sodium hydroxide results in increase in whiteness index of cotton fabric. Final liquor pH is the result from NaOH addition. Higher final liquor pH is positively correlated to higher water absorbency and higher whiteness of cotton fabric.

TABLE 3
Effect of Carbohydrate Oxidase and NaOH

| | Peroxide generation | | | | | |
|---|---|---|---|---|---|---|
| Sam- | Carbohydrate | | Bleaching | | | |
| ple | Oxidase | Glucose | NaOH | Final | Absorbency | CIE |
| # | (U/ml) | (g/l) | (g/l) | pH | (Second) | WI |
| S1 | 0.1 | 5 | 0 | 6.73 | 4.4(3-5) | 27.47 |
| S2 | 0.1 | 5 | 2 | 8.00 | N/A* | 23.73 |
| S3 | 0.1 | 5 | 4 | 11.69 | <1 | 34.79 |
| S4 | 0.1 | 5 | 8 | 12.37 | <1 | 42.62 |
| S5 | 0.5 | 5 | 0 | 6.34 | 6.0(5-7) | 26.38 |
| S6 | 0.5 | 5 | 2 | 8.12 | 1.4(1-2) | 29.95 |
| S7 | 0.5 | 5 | 4 | 11.80 | <1 | 42.27 |
| S8 | 0.5 | 5 | 8 | 12.40 | <1 | 48.35 |
| S9 | 1.5 | 5 | 0 | 5.14 | 4.0(3-6) | 20.06 |
| S10 | 1.5 | 5 | 2 | 8.45 | 1.2(1-2) | 26.85 |
| S11 | 1.5 | 5 | 4 | 11.90 | <1 | 42.27 |
| S12 | 1.5 | 5 | 8 | 12.45 | <1 | 53.38 |

*N/A: not measured

### Example 4

### Effect of NaOH and Silicate on Whiteness

All materials and chemicals were essentially the same as in Example 1. The peroxide generation and bleach experimental were the same as in Example 1 except that the amount of carbohydrate oxidase, glucose and sodium hydroxide varied. The value of whiteness index and absorbency of cotton fabric were measured using the same methods in Example 1.

Table 4 shows the value of whiteness index and absorbency results. Increase NaOH dose results in increase in absorbency and whiteness of cotton fabric. An optimal pH is about 12.2 in this experiment. Addition of silicate results in increase of fabric whiteness.

TABLE 4
Impact of NaOH and silicate on fabric properties

| | Peroxide generation | | | | | | |
|---|---|---|---|---|---|---|---|
| | Carbohydrate | | Bleaching | | | | |
| Sample | Oxidase | Glucose | Silicate | NaOH | | Absorbency | CIE |
| # | (U/ml) | (g/l) | (g/l) | (g) | Final pH | (second) | WI |
| S1 | 3 | 6 | 0 | 0 | 4.3 | 1.3(1-2) | 19.32 |
| S2 | 3 | 6 | 3 | 0 | 5.8 | 1.0 | 34.67 |
| S3 | 3 | 6 | 0 | 1 | 6.9 | <1 | 27.24 |
| S4 | 3 | 6 | 3 | 1 | 7.7 | <1 | 42.57 |
| S5 | 3 | 6 | 0 | 2 | 8.8 | <1 | 36.69 |
| S6 | 3 | 6 | 3 | 2 | 9.0 | <1 | 39.17 |
| S7 | 3 | 6 | 0 | 3 | 11.2 | <1 | 46.09 |
| S8 | 3 | 6 | 3 | 3 | 11.1 | <1 | 51.62 |
| S11 | 3 | 6 | 0 | 6 | 12.0 | <1 | 59.14 |
| S12 | 3 | 6 | 3 | 6 | 12.0 | <1 | 65.70 |
| S13 | 3 | 6 | 0 | 8 | 12.2 | <1 | 65.65 |
| S14 | 3 | 6 | 3 | 8 | 12.2 | <1 | 70.31 |
| S15 | 3 | 6 | 0 | 10 | 12.4 | <1 | 60.63 |
| S16 | 3 | 6 | 3 | 10 | 12.4 | <1 | 68.41 |

### Example 5

### Substrate Specificity of Carbohydrate Oxidase Base on the Same Weight

All materials and chemicals were essentially the same as in Example 1. The peroxide generation and bleach experimental were the same as in Example 1 except that the amount of Carbohydrate Oxidase, glucose and sodium hydroxide varied. The value of whiteness index and absorbency of cotton fabric were measured using the same methods in Example 1. After bleaching, liquor pH was measured and liquor color was also observed and recorded.

Table 5 shows the value of whiteness index and absorbency results. Based on the same weight of substrate, the specific activity of Carbohydrate Oxidase is ranked from high to low as: a-glucose>xylose>cellobiose>maltose>arabinose>galactose>fructose>mannose. All sugar tested in this study can be the substrate of Carbohydrate Oxidase.

TABLE 5
Substrate specificity of Carbohydrate Oxidase based on weight

| | Peroxide generation | | | | | | |
|---|---|---|---|---|---|---|---|
| | Carbohydrate | | | Bleaching | | | |
| | Oxidase | Sugar | Sugar | NaOH | Final | Color of | |
| Sample # | (U/ml) | (6 g/l) | (mmol) | (g/l) | pH | Solution | CIE WI |
| S1 | 3 | arabinose | 40 | 8 | 12.2 | Brown | 40.06 |
| S2 | 0 | arabinose | 40 | 8 | 12.2 | Brown | 31.19 |
| S3 | 3 | xylose | 40 | 8 | 12.3 | Yellow | 50.56 |
| S4 | 0 | xylose | 40 | 8 | 12.2 | Brown | 32.28 |
| | | alpha- | | | | | |
| S5 | 3 | glucose | 33 | 8 | 12.3 | Yellow | 59.60 |
| | | alpha- | | | | | |
| S6 | 0 | glucose | 33 | 8 | 12.2 | Brown | 34.80 |
| | | | | | | Medium | |
| S7 | 3 | galactose | 33 | 8 | 12.2 | brown | 43.73 |
| S8 | 0 | galactose | 33 | 8 | 12.2 | Brown | 39.14 |
| S9 | 3 | fructose | 33 | 8 | 12.2 | Brown | 38.65 |
| S10 | 0 | fructose | 33 | 8 | 12.2 | Brown | 36.07 |
| S11 | 3 | mannose | 33 | 8 | 12.2 | Brown | 37.95 |
| S12 | 0 | mannose | 33 | 8 | 12.2 | Brown | 36.97 |
| S13 | 3 | cellobiose | 18 | 8 | 12.3 | Yellow | 52.89 |
| S14 | 0 | cellobiose | 18 | 8 | 12.2 | Brown | 36.30 |
| S15 | 3 | maltose | 17 | 8 | 12.3 | Yellow | 51.92 |
| S16 | 0 | maltose | 17 | 8 | 12.2 | Brown | 38.41 |

### Example 6

### Substrate Specificity of Carbohydrate Oxidase Base on the Same Molarity

All materials and chemicals were essentially the same as in Example 1. The peroxide generation and bleach experimental were the same as in Example 1 except that the amount of carbohydrate oxidase, glucose and sodium hydroxide varied. The value of whiteness index and absorbency of cotton fabric were measured using the same methods in Example 1. After bleaching, liquor pH was measured and liquor color was also observed and recorded.

Table 6 shows the value of whiteness index and absorbency results. Except dextrin, all other sugars are suitable to be substrates of carbohydrate oxidase. Since dextrin is the only polymer used here, dextrin of 1120 mg was used in each beaker for 14 gram fabric bleach. Based on the same mole of sugar, the substrate specificity of carbohydrate oxidase is ranked as: alpha-glucose>beta-glucose>xylose=beta-lactose>cellubiose=maltotriose>maltose.

TABLE 6
Substrate specificity of Carbohydrate Oxidase based on the same molarity

| | Peroxide generation | | | | | | |
|---|---|---|---|---|---|---|---|
| | Carbohydrate | | Bleaching | | | | |
| | Oxidase | Sugar | NaOH | Final | Color of | | Absorbency |
| Sample # | (U/ml) | (22 mM) | (g/l) | pH | Solution | CIE WI | (second) |
| S1 | 3 | Xylose | 8 | 12.1 | yellow | 52.56 | <1 |
| S2 | 0 | Xylose | 8 | 12.1 | yellow+ | 43.72 | <1 |
| S3 | 3 | Beta- | 8 | 12.1 | yellow | 55.48 | <1 |
| | | glucose | | | | | |
| S4 | 0 | Beta- | 8 | 12.1 | yellow+ | 44.17 | <1 |
| | | glucose | | | | | |
| S5 | 3 | Alpha- | 8 | 12.2 | yellow | 58.64 | <1 |
| | | glucose | | | | | |
| S6 | 0 | Alpha- | 8 | 12.1 | yellow+ | 48.03 | <1 |
| | | glucose | | | | | |
| S7 | 3 | cellobiose | 8 | 12.1 | yellow | 50.34 | <1 |
| S8 | 0 | cellobiose | 8 | 12.0 | brown | 35.52 | <1 |
| S9 | 3 | maltose | 8 | 12.0 | brown | 47.84 | <1 |
| S10 | 0 | maltose | 8 | 12.1 | yellow | 29.23 | <1 |
| S11 | 3 | maltotriose | 8 | 11.8 | brown+ | 50.33 | <1 |
| S12 | 0 | maltotriose | 8 | 12.1 | yellow | 35.61 | <1 |
| S13 | 3 | Beta- | 8 | 12.2 | yellow | 53.64 | <1 |
| | | lactose | | | | | |
| S14 | 0 | Beta- | 8 | 12.0 | brown | 37.38 | <1 |
| | | lactose | | | | | |
| S15 | 3 | Dextrin | 8 | 12.2 | yellow | 50.38 | <1 |
| S16 | 0 | Dextrin | 8 | 12.2 | yellow | 50.89 | <1 |

### Example 7

### Cotton Bleaching with Amylase and Carbohydrate Oxidase

A 100% cotton woven fabric 428R (TestFabrics) contains starch as sizing component and has not been chemically treated after weaving. A 12 g swatch was treated in a Labomat (Mathis) beaker containing 120 ml solution at each condition. The solution contained 0.5 g/l Kierlon jet B. 20 mM sodium phosphate buffer pH 7.0, 0.3 g/l calcium chloride dehydrate (Fisher Scientific), 2 g/l alpha-amylase AQUAZYM™ 240L (Novozymes North America, Inc.), and in some cases, 82 mg/l glucoamylase SPIRIZYME™ PLUS FG (Novozymes North America, Inc). The treatment was conducted at 50 rpm, 50° C. for 60 minutes. Then 1.7 ml/beaker of 0.21 g/l silicate was added, and pH was adjusted with 3.3 ml/beaker of 0.3 g/ml NaOH solution. The beaker was heated to 95° C. at 3° C./min and the temperature was kept for 60 minutes. Swatches were then rinsed and dried.

The fabric whiteness index was measured in the same way as in Example 1. Combined alpha-amylase with carbohydrate oxidase treatment improves cotton fabric whiteness significantly compared to alpha-amylase treatment alone. Addition of glucoamylase further improves fabric whiteness.

TABLE 7

| | | | Carbo- | |
|---|---|---|---|---|
| | | | hydrate | Whiteness |
| Sample | AQUAZYME ™ | SPIRIZYME ™ | Oxidase | Index |
| # | (g/l) | Plus (mg/l) | (U/ml) | (Ganz 82) |
| 1 | 2 | 0 | 0 | 18.6 |
| 2 | 2 | 0 | 0.25 | 45.0 |
| 3 | 2 | 0 | 3 | 46.8 |
| 4 | 2 | 82 | 3 | 51.1 |

### Example 8

Measurement of the Activity of Fatty Acid Oxidizing Enzymes on Linoleic Acid

An “Oxi 3000 Oximeter” (WTW, Weilheim, Germany) with a TriOxmatic 300 oxygen electrode and a standard reaction volume of 4 ml was used.

10 mg linoleic acid (10 ml 60% linoleic acid) was dissolved in 1 ml ethanol, and 2 microliters Tween 20 was added. From this stock substrate solution 50 microliters was added into a reaction beaker containing 3.85 ml buffer solution (Britton-Robinson: 100 mM of Phosphoric-, Acetic- and Boric acid; pH adjusted with NaOH) with a small stir bar allowing the solution to be mixed well, and the oxygen electrode was inserted into the reaction beaker. 100 microliters purified enzyme solution was added, viz. (a) lipoxygenase derived from Magnaporthe salvinii at a concentration of approx. 0.4 mg/mL; or (b) lipoxygenase derived from Gaeumannomyces. graminis at a concentration of approx. 0.76 mg/ml (which means approximately 0.02 mg/mL in the final reaction). These lipoxygenases were prepared as previously described. The temperature was 25° C. The concentration of dissolved oxygen (mg/l) is measured and plotted as a function of time (min.). The enzymatic activity is calculated as the slope of the linear part of the curve (mg/l/min.) after addition of the enzyme. The baseline was corrected by subtraction when relevant, meaning that if the curve showing oxygen concentration as a function of time had a slope of above about 0.05 mg oxygen/m/min before addition of the fatty acid oxidizing enzyme (i.e. the control), this value was subtracted from the sample slope value.

Table 8 below shows the results of the experiments.

TABLE 8

Fatty Acid Oxidizing Enzyme

| | (a) LOX from | (b) LOX from |
|---|---|---|
| | M. salvinii mg | G. graminis mg |
| pH | O₂/mL/min | O₂/mL/min |
| 2 | 0.0 | 0.0 |
| 4 | 0.4 | 0.1 |
| 5 | 0.7 | 0.4 |
| 6 | 1.1 | 0.4 |
| 7 | 1.0 | 0.4 |
| 8 | 0.7 | 0.5 |
| 9 | 0.8 | 0.4 |
| 10 | 0.7 | 0.4 |
| 11 | 0.6 | 0.2 |

### Example 9

Fatty Acid Oxidizing Enzymes

Four enzymes, viz. two laccases and two lipoxygenases were tested as described below. The laccase derived from Polyporus pinsitus had a MW by SDS-Page of 65 kDa, a pl by IEF of 3.5, and an optimum temperature at pH 5.5 of 60° C. The laccase derived from Coprinus cinereus had a MW by SDS-Page of 67-68 kDa, a pl by IEF of 3.5-3.8, and an optimum temperature at pH 7.5 of 65° C. The enzymes were prepared and purified as described in WO 96/00290 and U.S. Pat. No. 6,008,029. The two lipoxygenases were derived from Magnaporthe salvinii and Gaeumannomyces graminis, and they were prepared as described previously.

The enzyme dosage was adjusted to ensure, maximum absorbancy increase per minute at 234 nm/530 nm, viz in the range of 0.1-0.25 absorbancy units per minute.

Substrate solution: 11.65 mg linoleic acid (60% Sigma), as well as 12.5 ml 0.56 mM Syringaldazine (Sigma) in ethanol was mixed with deionized water to a total volume of 25 ml.

50 microliters of the enzyme preparation to be tested was transferred to a quartz cuvette containing 900 microliters phosphate buffer (50 mM, pH 7.0) and 50 microliters of the substrate solution. The cuvette was placed in a spectrofotometer, thermostated at 23° C., and the absorbancies at 234 nm and 530 nm were measured as a function of time. The absorbancy at 530 nm is indicative of degradation of syringaldazine, whereas the absorbancy at 234 nm is indicative of degradation of linoleic acid. The absorbancy increase as a function of time is calculated on the basis of minutes 2 to 4 of the reaction time, i.e., d(A₂₃₄)/dt, as well as d(A₅₃₀)/dt.

The results are shown in Table 9 below. Of these four enzymes, only the two lipoxygenases qualify as a fatty acid oxidizing enzyme as defined herein. This is because RRD=Reaction Rate Difference=(dA₂₃₄/dt−dA₅₃₀/dt) is above zero only for these two enzymes.

TABLE 9

| | | | dA₂₃₄/dt − |
|---|---|---|---|
| | dA₅₃₀/dt | dA₂₃₄/dt | dA₅₃₀/dt |
| Enzyme | (units/min) | (units/min) | (units/min) |
| Polyporus pinsitus | 0.20 | 0.002* | −0.20 |
| laccase | | | |
| Magnaporthe salvinii | 0.0001* | 0.13 | 0.13 |
| lipoxygenase | | | |
| Coprinus cinereus | 0.17 | −0.001* | −0.17 |
| laccase | | | |
| Gaeumannomyces | −0.03* | 0.21 | 0.21 |
| graminis lipoxygenase | | | |

*this is equivalent to zero activity (analytical inaccuracy)

### Example 10

Lipoxygenase (LOX) Bleaching of Cotton

Cotton fabric is 100% cotton interlock knit 4600 (Ramseur Interlock Knit, Inc., NC). The cotton fabric was cut into 19×19 cm² swatches (about 6.0 g per swatch).

Lipoxygenase from Magnaporthe salvinii was cloned and expressed in Aspergillus oryzae as described in Example 2 of WO 02/086114. The enzyme was purified and stored at −18° C. prior to application.

Buffer A (50 mM) was made by dissolving 26.95 g Na₂HPO₄ 7H₂O in 2 liters deionized water, and the pH was adjusted to 7 with 5 M HCl. Buffer B (50 mM) was made by dissolving 38.23 g Na₂B₄O₇ 10H₂O in 2 liters deionized water, the pH was adjusted to 9.5 with 30% NaOH. About 1 g Kieralon Jet B (0.5 g/l) was added in each buffer solution.

During the experiment, 120 ml buffer was added to each beaker containing a fabric swatch. Linoleic acid (99%, batch 71k2050) and lipoxygenease were then added sequentially into each beaker. Beakers were then sealed and installed in Labomat equipment (type BFA Beaker from Werner Mathis, N.C.). The treatment was conducted at 50 rpm, 50° C. (3° C./min gradient) for 120 minutes. All swatches were then taken out and rinsed with cold water. The swatches were washed in a US-type washing machine at 40° C., cold rinsed twice, and then tumble dried for 50 minutes. Thereafter all swatches were equilibrated at 21° C. (70° F.) and 65% relative humidity for more than 24 hours. The wettability of the swatches was measured according to AATCC method 79 (incorporated by reference). The Fabric whiteness was measured using Macbeth Color-eye 7000 spectrophotometer.

The result of this test is shown in Table 10 below and shows the fabric whiteness after treatment at 50° C. for 2 hours. In the control with the absence of both lipoxygenase (LOX) and lenoleic acid (LA), or the absence of LA, fabric whiteness index changed very little in both pH 7.0 and 9.5 treatments. In the presence of LOX and LA, fabric whiteness index was significantly higher, indicating bleaching effect. The bleaching was more effective at pH 7 than pH 9.5.

TABLE 10

| | Treating conditions | | | Whiteness | | | | |
|---|---|---|---|---|---|---|---|---|
| | | | Lenoleic | Index (WI | | Weight | Wetting | |
| | | Lipoxygenase | acid | CIE | Hunter | Loss | (sec.) | |
| Swatch # | pH | U/ml | mL/mL | Ganz82 | 60 | (%) | Average | STDEV |
| 1 | 7 | 0 | 0 | 24.1 | 58.1 | 3.1 | >60 | 0.0 |
| 2 | 7 | 4.8 | 0 | 24.4 | 58.3 | 3.1 | >60 | 0.0 |
| 3 | 7 | 4.8 | 3.3 × 10⁻³ | 27.3 | 59.7 | 3.3 | >60 | 0.0 |
| 4 | 9.5 | 0 | 0 | 23.7 | 57.9 | 3.0 | >60 | 0.0 |
| 5 | 9.5 | 4.8 | 0 | 22.8 | 57.5 | 2.9 | >60 | 0.0 |
| 6 | 9.5 | 4.8 | 3.3 × 10⁻³ | 27.2 | 59.7 | 3.4 | >60 | 0.0 |
| Untreated | | | | 1.5 | 47.1 | | >180 | 0.0 |

### Example 11

NaOH Enhanced Lipoxygenase (LOX) Bleaching of Cotton

The enzyme, fabric, and chemicals were the same as in Example 10. Buffers were pH 7 and pH 9.5 made the same way with the addition of Kieralon Jet B as in Example 10. The same protocol was conducted as described in the experimental protocol of Example 10, except that after treatment at 50° C. for 120 minutes, NaOH (3 g/l) was added in each beaker and the beakers were heated to 95° C. (3° C./min gradient) and kept for 30 minutes. The fabric swatches were rinsed the same way as in Example 10. After equilibrating at 21° C. (70° F.) and 65% relative humidity for more than 24 hours, the fabric swatches were analyzed as done in Example 10.

The results of this example are shown Table 11 below. First all fabric swatches had substantially higher whiteness level than those in Example 10 due to the removal of color impurities by NaOH boiling. Thereafter, in the presence of LOX and LA, fabric whiteness level (Ganz 82) reached as high as about 53, which was significantly higher than any other control. This higher whiteness level may be due to the activation of hydroperoxide in alkaline medium. The table also shows that the lipoxygenase and linoleic acid system gives higher fabric weight loss and better fabric wettability than any control.

TABLE 11

| | Treating conditions | | | Whiteness | | | | |
|---|---|---|---|---|---|---|---|---|
| | | | Lenoleic | Index (WI | | Weight | Wetting | |
| | | Lipoxygenase | acid | CIE | Hunter | Loss | (sec.) | |
| Swatch # | pH | U/ml | mL/mL | Ganz82 | 60 | (%) | Average | STDEV |
| 1 | 7 | 0 | 0 | 41.7 | 67.1 | 5.4 | 2.7 | 1.2 |
| 2 | 7 | 4.8 | 0 | 41.0 | 66.8 | 5.3 | 3.8 | 0.8 |
| 3 | 7 | 4.8 | 3.3 × 10⁻³ | 52.7 | 73.2 | 5.6 | <1 | 0.0 |
| 4 | 9.5 | 0 | 0 | 30.3 | 61.2 | 4.4 | 30.0 | 13.4 |
| 5 | 9.5 | 4.8 | 0 | 30.0 | 61.1 | 4.4 | 18.0 | 4.6 |
| 6 | 9.5 | 4.8 | 3.3 × 10⁻³ | 43.8 | 68.4 | 4.6 | <1 | 0.0 |
| Untreated | | | | 1.5 | 47.1 | | >180 | 0.0 |

### Example 12

Lipoxygenase (LOX) Assisted Scouring of Cotton Knit

Cotton fabric is 100% cotton interlock knit 4600 (Ramseur Interlock Knit, Inc., NC). The cotton fabric was cut into 19.5×19.5 cm² swatches (about 7.0 g per swatch). Buffer (20 mM) was made by dissolving 22.86 g Na₂B₄O₇ 10H₂O in 3 liters deionized water, the pH was adjusted to 9.25 with 30% NaOH. About 1.5 g Kieralon Jet B (0.5 g/l) was added in the buffer solution.

Buffer 70 mL, pH 9.25, was added to each beaker containing a fabric swatch. Linoleic acid (L-2376, lot 072K1228) (0.4 ml/beaker), linolenic acid (L-2376, lot 072K1228) (5.7×10⁻³ mL/mL), pectate lyase (BIOPREP™ 3000L) (2.14 APSU/g fabric), and lipoxygenease from Magnaporthe salvinii (8.2 U/mL) were then added into each beaker. Beakers were then sealed and Installed In Labomat equipment (type BFA Beaker from Werner Mathis, N.C.). The treatment was conducted at 50 rpm, 50° C. (3° C./min gradient) for 30 minutes. 1 g/L Na₂CO₃H₂O (Aldrich) and 0.2 g/L sodium ethylenediamine tetracetate (EDTA) (Dexter Chemical) were added in Labomat beakers. The beakers were heated to 90° C. (3° C./min gradient) and kept for 10 minutes. The water in the beakers was drained after cooled down to about 70° C. All swatches were then taken out and rinsed with warm water (60° C.) for about 10 minutes and then washed in a US-type washing machine at 40° C. and then cold rinsed twice. They were then air dried.

After all swatches were equilibrated at 21° C. (70° F.) and 65% relative humidity for at least 24 hours, their wettability was measured according to MTCC method 79 (hereby incorporated by reference). Fabric whiteness was measured using Macbeth Color-eye 7000 spectrophotometer. Fabric whiteness (CIE L*a*b* values and CIE Ganz 82) and fabric wettability (wetting time in seconds with ±standard deviation) are shown in Table 12 below. Lipoxygenase was shown to enhance fabric wettability when used together with pectate lyase. Regardless of the presence of pectate lyase, fabrics treated by lipoxygenase together with either linelonic acid (LNA) or linoleic acid (LA) have excellent wettability. Fabric treated with lipoxygenase and linoleic add has higher whiteness.

TABLE 12

| | | | | | Wetting time |
|---|---|---|---|---|---|
| Treatment | L* | a* | b* | CIE Ganz 82 | (seconds) |
| Control | 88.1 | 0.7 | 9.6 | 25.9 | >120 |
| PAL + LOX | 88.1 | 0.7 | 9.6 | 26.2 | 17.5(+/−2.4) |
| LOX + LNA | 88.9 | 0.1 | 11.6 | 18.2 | <1 |
| PAL + LOX + LNA | 88.8 | 0.1 | 11.6 | 18.1 | <1 |
| LOX + LA | 89.6 | 0.1 | 9.0 | 32.4 | <1 |
| PAL + LOX + LA | 89.6 | 0.0 | 9.1 | 32.1 | <1 |

### Example 13

### Lipoxygenase (LOX) for Scouring of Cotton Woven Fabric

Cotton fabric is chemically desized 100% cotton woven type 428U (Tesffabrics, Pa.). Cotton fabric was cut into 15×25.5 cm² swatches (about 9.0 g per swatch). The pectate lyase and the lipoxygenase were the same as in Example 12. The cutinase was a variant of a cutinase derived from Humicola insolens, DSM1800 with activity of 17.2 KLU/g (batch PPW21399). Other chemicals and buffer were the same as in Example 12.

Buffer 90 ml pH 9.25 was added to each beaker containing a fabric swatch. Linoleic acid (4.4×10⁻³ mL/mL), pectate lyase (2.14 APSU/g fabric), Cutinase (17 LU/g fabric), and lipoxygenease (6.4 U/mL) were then added into each beaker. The experiment was conducted the same as in Example 12.

After all swatches were equilibrated at 21° C. (70° F.) and 65% relative humidity for at least 24 hours, their wettability and whiteness were measured as described in Example 12. Prior to and after the treatment, fabric weight was obtained after equilibrated at 21° C. (70° F.), 65% RH for at least 24 hours. The percent of weight loss was determined using following equation:
Weight loss (%)=(Weight_{before}−Weight_{after})/Weight_{before}×100

Fabric whiteness (CIE L*a*b* values and CIE Ganz 82), weight loss (%), and wettability are shown in Table 13 below. Lipoxygenase treatment gives higher percentage of fabric weight loss than control. Lipoxygenase and linoleic acid treatment gives higher weight loss and improved fabric whiteness compared to the control. The addition of lipoxygenase generates higher percentage of fabric weight loss than pectinase treatment only. The addition of lipoxygenas and linoleic acid improves fabric whiteness.

TABLE 13

| | | | | CIE | Weight | Wetting time |
|---|---|---|---|---|---|---|
| Treatment | L* | a* | b* | Ganz 82 | Loss (%) | (Seconds) |
| Control | 84.7 | 1.8 | 9.4 | 18.7 | 1.20 | <1 |
| LOX | 84.8 | 1.8 | 9.4 | 18.8 | 1.52 | <1 |
| LOX + LA | 86.1 | 1.6 | 9.6 | 21.2 | 1.52 | <1 |
| PAL | 84.8 | 1.8 | 9.3 | 19.3 | 1.24 | <1 |
| PAL + LOX | 84.8 | 1.8 | 9.4 | 18.7 | 1.45 | <1 |
| PAL + LOX + LA | 86.0 | 1.6 | 9.5 | 21.5 | 1.53 | <1 |
| PAL + CUT | 85.0 | 1.7 | 9.2 | 20.3 | 1.67 | <1 |
| PAL + CUT + LOX | 84.9 | 1.8 | 9.3 | 19.8 | 1.32 | <1 |
| PAL + CUT + | 86.7 | 1.5 | 9.2 | 24.3 | 1.47 | <1 |
| LOX + LA | | | | | | |

LOX: lipoxygenase;
LA: linoleic acid;
PAL: pactate lyase;
CUT: cutinase.

### Example 14

Lipoxygenase and Amylase for Desizing and Scouring of Cotton

Cotton fabric is 100% cotton woven type 428R (Tesffabrcs, Pa.). It was cut into 15×15.2 cm² swatches (about 7.7 g per swatch) in this study. Lipoxygenase and cutinase were the same as In Example 11. Amylase is AQUAZYME™ ULTRA 1200L, a commercial product made by Novozymes A/S (Denmark). Other chemicals and buffer pH 7.0 were the same as in Example 8 except buffer is 20 mM sodium phosphate.

About 77 ml buffer was added in each beaker that contains a fabric swatch. AQUAZYM™ Ultra was diluted 10× and then added 0.4 mL/beaker. Cutinase was added in a concentration of 11 LU/mL. Linoleic acid (5.2×10⁻³ mL/mL) and lipoxygenase (7.4 U/mL) were added. Desizing was carried out at 70° C., 50 rpm for 30 minutes in a Labomat machine. After the treatment, swatches were rinsed in hot water (60° C.) and cold water (25° C.) for 10 minutes each.

After all swatches were equilibrated at 21° C. (70° F.) and 65% relative humidity for at least 24 hours, their wettability and whiteness were measured as described in Example 13. The starch residue on fabric was evaluated in according with the TEGEWA violet scale (Textile Praxis International 1981(12), p. 9-11), where 1 is not desized, 9 is completely desized. Two lots of 100% cotton woven 428U (commercially desized from Tesffabrics) were rated 5.3 and 6.5.

Table 14 below shows fabric whiteness, wettability, and starch residue in TEGEWA scale. Lipoxygenase and linoleic acid improve fabric whiteness and wettability in either amylase desizing or amylase and cutinase desizing. The addition of lipoxygenase to cutinase and amylase desizing solution improves fabric wettability.

TABLE 14

| | | | | CIE | Wetting time | |
|---|---|---|---|---|---|---|
| Name | L* | a* | b* | Ganz 82 | (seconds) | Tegewa |
| Control | 87.2 | 1.1 | 9.5 | 24.3 | ≦1 | 1.0 |
| AmL | 87.1 | 1.1 | 9.5 | 23.9 | 8.3(+/−1.0) | 3.3 |
| AmL + LOX | 86.9 | 1.1 | 9.9 | 21.4 | 10.7(+/−0.5) | 3.5 |
| AmL + LOX + | 87.7 | 0.9 | 10.0 | 22.9 | 1.0(+/−0.0) | 2.8 |
| LA | | | | | | |
| AmL + Cut + | 87.2 | 1.1 | 9.7 | 23.0 | 2.5(+/−0.5) | 3.3 |
| LOX | | | | | | |
| Aml + Cut + | 88.0 | 0.9 | 9.1 | 28.0 | 1.8(+/−0.8) | 2.8 |
| LOX + LA | | | | | | |
| Untreated | 86.3 | 1.3 | 11.3 | 13.1 | >120 | 1.0 |

LOX: lipoxygenase;
LA: linoleic acid;
AmL: Amylase;
Cut: cutinase.

1. A method of treating textiles, in particular fabrics, fibers, or yarns comprising treating fabric, fiber, or yarn, in an aqueous medium, with a carbohydrate oxidase and/or a fatty acid oxidizing enzyme.

2. A method of claim 1, comprising treating fabric, fiber, or yarn, in an aqueous medium, with an effective amount of a carbohydrate oxidase having activity towards monosaccharides and at least one of di-saccharides and oligo-saccharides, and a substrate for said carbohydrate oxidase.

3. The method according to claim 1, wherein the fabric, fiber, or yarn is a cellulosic material.

4. The method according to claim 3, wherein the cellulosic material is a cotton-containing material.

5. The method according to claims 1, wherein the carbohydrate oxidase is derived from fungi, from bacteria, or from algae.

6. The method according to claim 5, wherein the carbohydrate oxidase is derived from Microdochium.

7. The method according to claim 6, wherein the carbohydrate oxidase is derived from Microdochium nivale.

8. The method according to claim 1, wherein the concentration of the carbohydrate oxidase is in the range of from about 0.05 U/ml to about 10 U/ml.

9-10. (canceled)

11. The method according to claim 1, wherein the carbohydrate substrate is selected from the group consisting of alpha-glucose, beta-glucose, xylose, cellobiose, maltose, arabinose, galactose, fructose, maltriose, lactose, and mannose.

12. The method according to claim 1, wherein the concentration of the concentration of the carbohydrate oxidase substrate is from about 1 to about 200 mM.

13-14. (canceled)

15. The method according to claim 1, wherein the peroxide generating step is carried out at a pH in the range of about 5.5 to about 9.

16. (canceled)

17. The method according to claim 1, wherein the aqueous medium is added a peroxide activator.

18. The method according to claim 17, wherein the activator is silicate.

19. The method according to claim 1, wherein the substrate is generated in situ with another enzyme or chemical system.

20. The method according to claim 19, wherein the enzyme system comprises at least one of the enzymes from the group consisting of cellulase, xylanase, mannanase, amylase, arabinase, galactase, pectinase and glucanase.

21. A composition for use in a method of treating fabrics, fibers, or yarns comprising a carbohydrate oxidase having activity towards monosaccharides and at least one of disaccharides and oligo-saccharides and a substrate for said carbohydrate oxidase.

22. A method of claims 1, comprising a step of treating the textile in an aqueous medium with one or more fatty acid oxidizing enzyme.

23. The method of claim 22, wherein the treatment is a bleaching step.

24. The method of claim 23, wherein the bleaching step is followed by an alkaline treatment step carried out at a pH above 8, preferably between 9 and 13.

25. (canceled)

26. The method of claim 22, wherein the treatment is a scouring step.

27-30. (canceled)

31. The method of claims 22, wherein the treatment is a desizing step.

32-47. (canceled)

48. A composition comprising a fatty acid oxidizing enzyme and in addition thereto at least one adjuvant, preferably a wetting agent, polymeric agent and/or dispersing agent.

49. The composition of claim 48, wherein the fatty acid oxidizing enzyme is a lipoxygenase, preferably is derived from the genus Magnaporthe, especially a strain of Magnaporthe salvinii.

50. The composition of claim 48, wherein the composition further comprises an enzyme selected from the group consisting of: a proteolytic enzyme, a lipolytic enzyme, a cellulolytic enzyme, an amylolytic enzyme, a pectolytic enzyme, an oxidase enzyme, or a peroxidase enzyme, or mixtures hereof.

51-61. (canceled)
